(19) United States
(12) Patent Application Publication
(10) Pub. No.: US 2014/0288721 A1
(43) Pub. Date: Sep. 25, 2014

(54) POWER LEVELING CONTROL METHOD AND POWER LEVELING CONTROL DEVICE

(71) Applicant: FUJITSU LIMITED, Kawasaki-shi (JP)

(72) Inventor: Toshiaki FUNAKUBO, Kawasaki (JP)

(21) Appl. No.: 14/299,795

(22) Filed: Jun. 9, 2014

Related U.S. Application Data
(63) Continuation of application No. PCT/JP2011/079227, filed on Dec. 16, 2011.

(51) Int. Cl. G05F 1/66

(52) U.S. Cl. CPC G05F 1/66
USPC 700/295

(57) ABSTRACT

In a system that includes a power supply, a plurality of demand units provided with a power storage device and a load, a power leveling control device that levels power supplied from the power supply to the demand units the remaining power amount of the power storage device of each of the demand units is obtained for each monitoring time. An individual target value for power supplied to each of the demand units is allocated in accordance with the overall target value. In this case, the individual target value of one demand unit is set to a value that is lower than the individual target value of another demand unit, when a remaining power amount of the another demand unit is smaller than a remaining power amount of the one demand unit. The power received from the power supply unit is controlled according to the individual target values.

### CROSS-REFERENCE TO RELATED APPLICATION

This application is a continuation application of International Application PCT/JP2011/079227 filed on Dec. 16, 2011 and designated the U.S., the entire contents of which are incorporated herein by reference.

### FIELD

The embodiments discussed herein are related to a power leveling control method, a power leveling control device.

### BACKGROUND

In recent years, to efficiently use power, a system has been used that controls, in a centralized manner, the supplying of power to a plurality of loads that consume power. As an example, a system is used wherein the amount of interchange power is determined for each dwelling, and a plurality of dwellings interchange power. In such a system, a plurality of dwellings are each provided with an electric cell charged during a time period with a low electricity rate (e.g., the middle of the night). Power is supplied from a dwelling with a sufficiently charged electric cell to a dwelling or shared facility lacking power. To interchange power, a controlling apparatus of the system estimates the amount of daily power use for each dwelling, and determines the amount of interchange power of each dwelling according to the amount of power use and the amount of power accumulated in the electric cell. In accordance with the amount of interchange power determined for each dwelling, the controlling apparatus supplies power to a dwelling or shared facility lacking power.
Patent document 1: Japanese Laid-open Patent Publication No. 2010-220428

### SUMMARY

According to an aspect of the embodiments, a method, that performs leveling power supplied from a power supply to a plurality of demand units, in a system that includes a power supply connected to a plurality of demand units each provided with a power storage device and a load. In the method, a power leveling control device obtains an overall target value for the total of the power supplied to the plurality of demand units. The remaining power amount of the power storage device of each of the demand units is obtained for each monitoring time. An individual target value for power supplied to each demand unit is allocated in accordance with the overall target value. The individual target value of one demand unit is set to a value that is lower than the individual target value of another demand unit, when the remaining power amount of the another demand unit is smaller than the remaining power amount of the one demand unit. The power supplied from the power storage device to the loads or the power supplied from the power supply to the power storage device is controlled according to the individual target values determined by the individual target determining unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating the configuration of a power centralized control system in accordance with a first embodiment;

FIG. 2 is a functional block diagram illustrating the configuration of a power centralized control system in accordance with the first embodiment;

FIG. 3 illustrates an example of power leveling control;

FIG. 4 illustrates an example of power leveling control in accordance with the first embodiment;

FIG. 5 illustrates the status of the supplying of power and the total of remaining power amounts for a situation in which leveling control is not performed comprehensively for a power centralized control system in accordance with the first embodiment;

FIG. 6A illustrates an exemplary status of the supplying of power to a first demand unit and an exemplary change in the remaining power amount of the first demand unit for a situation in which leveling control is not performed comprehensively for a power centralized control system in accordance with the first embodiment;

FIG. 6B illustrates an exemplary status of the supplying of power to a second demand unit and an exemplary change in the remaining power amount of the second demand unit for a situation in which leveling control is not performed comprehensively for a power centralized control system in accordance with the first embodiment;

FIG. 6C illustrates an exemplary status of the supplying of power to a third demand unit and an exemplary change in the remaining power amount of the third demand unit for a situation in which leveling control is not performed comprehensively for a power centralized control system in accordance with the first embodiment;

FIG. 6D illustrates an exemplary status of the supplying of power to a fourth demand unit and an exemplary change in the remaining power amount of the fourth demand unit for a situation in which leveling control is not performed comprehensively for a power centralized control system in accordance with the first embodiment;

FIG. 6E illustrates an exemplary status of the supplying of power to a fifth demand unit and an exemplary change in the remaining power amount of the fifth demand unit for a situation in which leveling control is not performed comprehensively for a power centralized control system in accordance with the first embodiment;

FIG. 7 depicts an individual target value and a remaining power amount for each demand unit for a situation in which leveling control is not performed comprehensively for a power centralized control system in accordance with the first embodiment;

FIG. 8A illustrates an exemplary status of the supplying of power to the first demand unit and an exemplary change in the remaining power amount of the first demand unit for a situation in which leveling control is performed comprehensively for a power centralized control system in accordance with the first embodiment;

FIG. 8B illustrates an exemplary status of the supplying of power to the second demand unit and an exemplary change in the remaining power amount of the second demand unit for a situation in which leveling control is performed comprehensively for a power centralized control system in accordance with the first embodiment;

FIG. 8C illustrates an exemplary status of the supplying of power to the third demand unit and an exemplary change in the remaining power amount of the third demand unit for a situation in which leveling control is performed comprehensively for a power centralized control system in accordance with the first embodiment;

FIG. 8D illustrates an exemplary status of the supplying of power to the fourth demand unit and an exemplary change in the remaining power amount of the fourth demand unit for a situation in which leveling control is performed comprehensively for a power centralized control system in accordance with the first embodiment;

FIG. 8E illustrates an exemplary status of the supplying of power to the fifth demand unit and an exemplary change in the remaining power amount of the fifth demand unit for a situation in which leveling control is performed comprehensively for a power centralized control system in accordance with the first embodiment;

FIG. 9 illustrates the status of the supplying of power and the total of remaining power amounts for a situation in which leveling control is performed comprehensively for a power centralized control system in accordance with the first embodiment;

FIG. 10 depicts an individual target value and a remaining power amount for each demand unit for a situation in which leveling control is performed comprehensively for a power centralized control system in accordance with the first embodiment;

FIG. 11A is a flowchart illustrating operations of a power centralized control system in accordance with the first embodiment;

FIG. 11B is a flowchart illustrating operations of a power centralized control system in accordance with the first embodiment;

FIG. 11C is a flowchart illustrating operations of a power centralized control system in accordance with the first embodiment;

FIG. 12A is a flowchart illustrating operations of a power centralized control system in accordance with a second embodiment.

FIG. 12B is a flowchart illustrating operations of a power centralized control system in accordance with the second embodiment;

FIG. 12C is a flowchart illustrating operations of a power centralized control system in accordance with the second embodiment;

FIG. 13 illustrates a situation in which the total of accumulated received power exceeds an overall target value;

FIG. 14A is a flowchart illustrating operations of a power centralized control system in accordance with a fourth embodiment;

FIG. 14B is a flowchart illustrating operations of a power centralized control system in accordance with the fourth embodiment;

FIG. 14C is a flowchart illustrating operations of a power centralized control system in accordance with the fourth embodiment; and

FIG. 15 illustrates the hardware configuration of a standard computer.

### DESCRIPTION OF EMBODIMENTS

The aforementioned system that controls the supplying of power to a plurality of loads that consume power according to the related art has the following problems. To interchange power between loads that consume power, such as dwellings and shared utilities, the amount of power use needs to be estimated for each load, and complicated control needs to be performed to exchange power between the loads. When, for example, the amount of power use is incorrectly estimated, the amount of power exchange that follows an estimation-based plan may become different from the amount of power that is actually exchangeable, thereby ruining the control. Inappropriately performing control for power exchange may cause an accident.

Preferred embodiments of the present invention will be explained with reference to accompanying drawings.

### First Embodiment

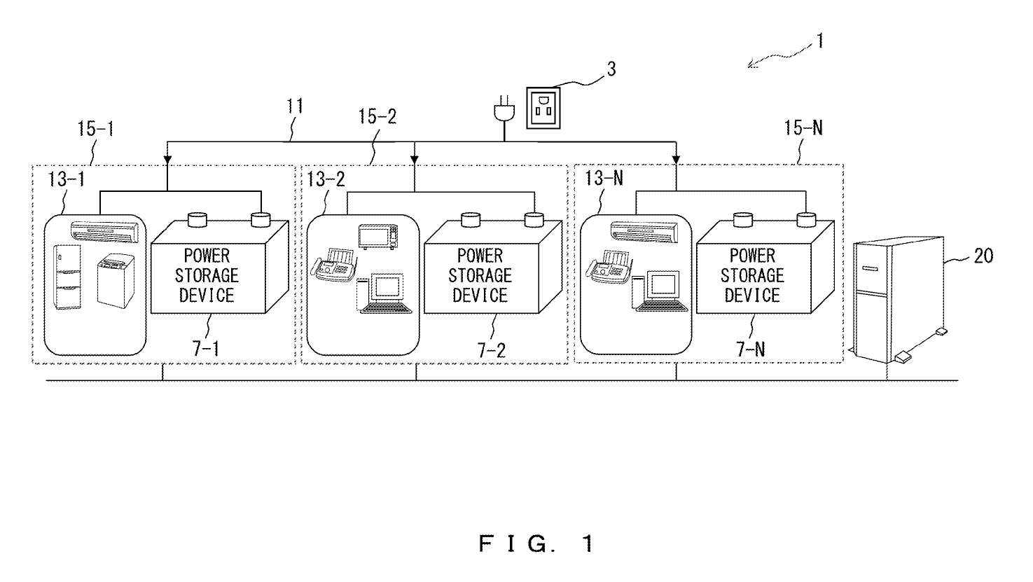

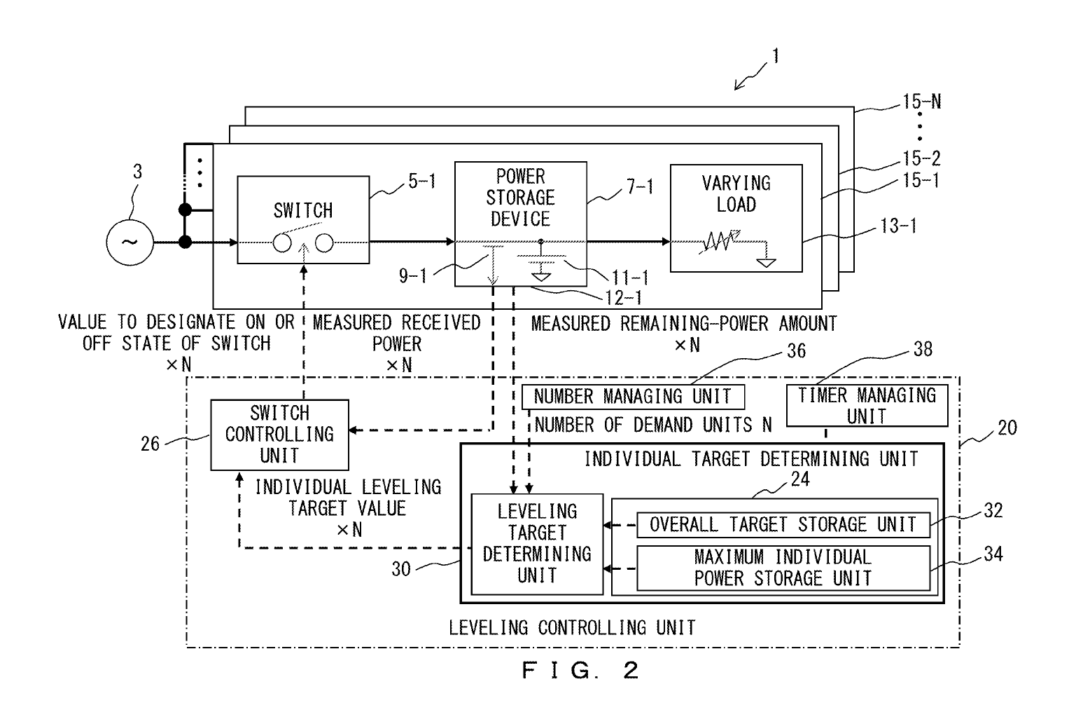

First, with reference to FIG. 1 to FIG. 8E, descriptions will be given of the configuration of a power centralized control system in accordance with a first embodiment and of the outline of operations in power leveling control. FIG. 1 is a diagram illustrating the configuration of a power centralized control system 1 in accordance with the first embodiment. FIG. 2 is a functional block diagram illustrating the configuration of the power centralized control system 1. As depicted in FIGS. 1 and 2, the power centralized control system 1 is a system controlled by a leveling controlling unit 20, wherein a plurality of demand units 15-1, 15-2, . . . , 15-N (all of which may be referred to as a “demand unit 15”) are connected to a power supply 3. The demand units 15-1, . . . , 15-N respectively include switches 5-1, . . . , 5-N, power storage devices 7-1, . . . , 7-N, and varying loads 13-1, . . . , 13-N. The switches 5-1, . . . , 5-N, the power storage devices 7-1, . . . , 7-N, and the varying loads 13-1, . . . , 13-N may respectively be referred to as “switch 5”, “power storage device 7”, and “varying load 13”. In the demand unit 15, the power storage device 7 and the varying load 13, which are connected to each other, are connected via the switch 5 to the power supply 3. The leveling controlling unit 20, intended to control the operation of the switch 5, is connected to the switch 5.

The power supply 3 is a commercial power supply. The switch 5 is connected in a switchable manner between the power supply 3 and a set of the power storage device 7 and the varying load 13. The leveling controlling unit 20 controls the switch 5 to establish or terminate the connection, i.e., to switch the connection between the power supply 3 and the set of the power storage device 7 and the varying load 13. The power storage devices 7 are each connected to a switch 5 and a varying load 13, and include received power measurement units 9-1, . . . , 9-N, electric cells 11-1, . . . , 11-N, and remaining power-amount measurement units 12-1, . . . , 12-N. The received power measurement units 9-1, . . . , 9-N, the electric cells 11-1, . . . , 11-N, and the remaining power amount measurement units 12-1, . . . , 12-N may respectively be referred to as “received power measurement unit 9”, “electric cell 11”, and “remaining power amount measurement unit 12”.

The received power measurement units 9 measure and output, to the leveling controlling unit 20, received power Pin_n(t) that the demand units 15-n receive from the power supply 3 (n ranges from 1 to N, each corresponding to any of the demand units 15, and this is also true for the descriptions hereinafter). In accordance with the opening or closing of the switch 5, the electric cell 11 accumulates a portion of the power received from the power supply 3 (closed circuit), or discharges and supplies the power to the varying load 13 (open circuit). The remaining power amount measurement unit 12 measures and outputs, to the leveling controlling unit 20, the remaining power amount of the electric cell 11.

Note that received power Pin_n(t) indicates the power received by a demand unit 15-n, and received power Pin(t) indicates the sum of the power received by all of the demand units 15. A remaining power amount Bn (t) indicates the amount of the power remaining in a demand unit 15-n at time t, and a remaining power amount Br (t) indicates the sum of the power remaining at time t in the electric cells 11 of all of the demand units 15. The accumulated total of the received power Pin(t) corresponding to a certain period and the accumulated total of the received power Pin_n(t) corresponding to the certain period are respectively indicated as accumulated received power Ein(t) and a accumulated received power Ein_n(t), which will be described hereinafter.

The varying load 13 is a load that receives supplied power and consumes a varying amount of power, e.g., an ordinary household or company. In FIG. 1, in a case where the outputs of the power supply 3, the inputs and the outputs of the electric cells 11, and the inputs of the varying loads 13 are different between AC power and DC power, an AC/DC converter is provided on an as-needed basis.

The leveling controlling unit 20 includes a target determining unit 22, a switch controlling unit 26, a number managing unit 36, and a timer managing unit 38. The target determining unit 22 includes an individual target determining unit 30 and a storage unit 24. The storage unit 24 includes an overall target storage unit 32 and a maximum individual power storage unit 34.

The timer managing unit 38 manages, for example, a demand-time-period timer and a monitoring time timer (neither of which is illustrated) so as to manage cycles. A demand time period T1, managed by the demand-time-period timer, indicates a period during which the amounts of the power received from the power supply 3 are added up. A monitoring time T2, managed by the monitoring time timer, indicates time intervals at which the leveling controlling unit 20 measures received power Pin(t).

The number managing unit 36 manages numbers assigned to the demand units 15 (e.g., 1 to N) so that each demand unit 15 can be controlled differently. The storage unit 24 is, for example, a random access memory (RAM). The storage unit 24 stores, for example, a program for controlling the operation of the leveling controlling unit 20, a remaining power amount input from the power storage device 7, and a determined individual target value. The overall target storage unit 32 of the storage unit 24 stores the overall leveling target value of the power centralized control system 1 determined in advance, and such a value is, for example, input from an outside using an input unit (not illustrated). The maximum individual power storage unit 34 stores the maximum power consumption Lmax(n) of each varying load 13, and such values are input in advance using an input unit (not illustrated).

The individual target determining unit 30 refers to the overall target storage unit 32 and the maximum individual power storage unit 34 so as to obtain an overall target value x and the maximum power consumption Lmax(n) of each varying load 13. According to, for example, the obtained overall target value x and a maximum power consumption Lmax (n) as well as a remaining power amount Bn(t) measured by the remaining power amount measurement unit 12, the individual target determining unit 30 determines the individual target value xn(t) of leveling control specific to time t for each of the demand units 15 corresponding to the numbers managed by the number managing unit 36. In addition, the individual target determining unit 30 outputs the determined individual target values xn(t) to the switch controlling unit 26.

In accordance with the individual target value xn(t) determined by the target determining unit 22 and the accumulated received power Ein_n(t) based on the received power Pin_n(t) input from the power storage device 7, the switch controlling unit 26 controls the switch 5 by outputting an operation signal for switching the connection state of the switch 5. The storage unit 24 may store the obtained received power Pin_n(t), the obtained remaining power amount Bn(t), and the determined individual target value xn(t). Details of a method for determining an individual target value xn(t) will be described hereinafter.

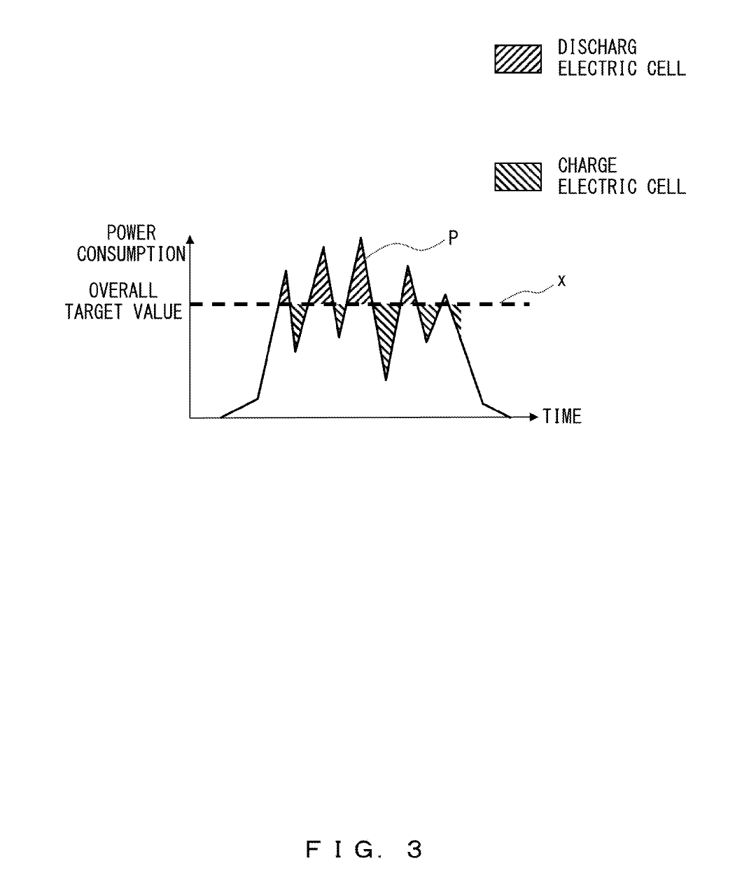

The following will describe power leveling control. FIG. 3 conceptually illustrates power leveling control, where a vertical axis indicates power consumption and a horizontal axis indicates time. As depicted in FIG. 3, when power consumption P is less than a target value x, a electric cell is charged with the power corresponding to the difference between the target value x and the power consumption P; when the power consumption is greater than the target value, the power corresponding to the difference between the power consumption P and the target value x is discharged from the electric cell. As in the case of the power centralized control system 1 illustrated in FIG. 2, a configuration may be used wherein the power consumption and the target value are the amounts of power corresponding to a unit time, and the switch 5 is opened or closed within the period of each time unit so as to perform switching between the charging and the discharging of the electric cell 11, thereby leveling the amounts of power corresponding to the time units.

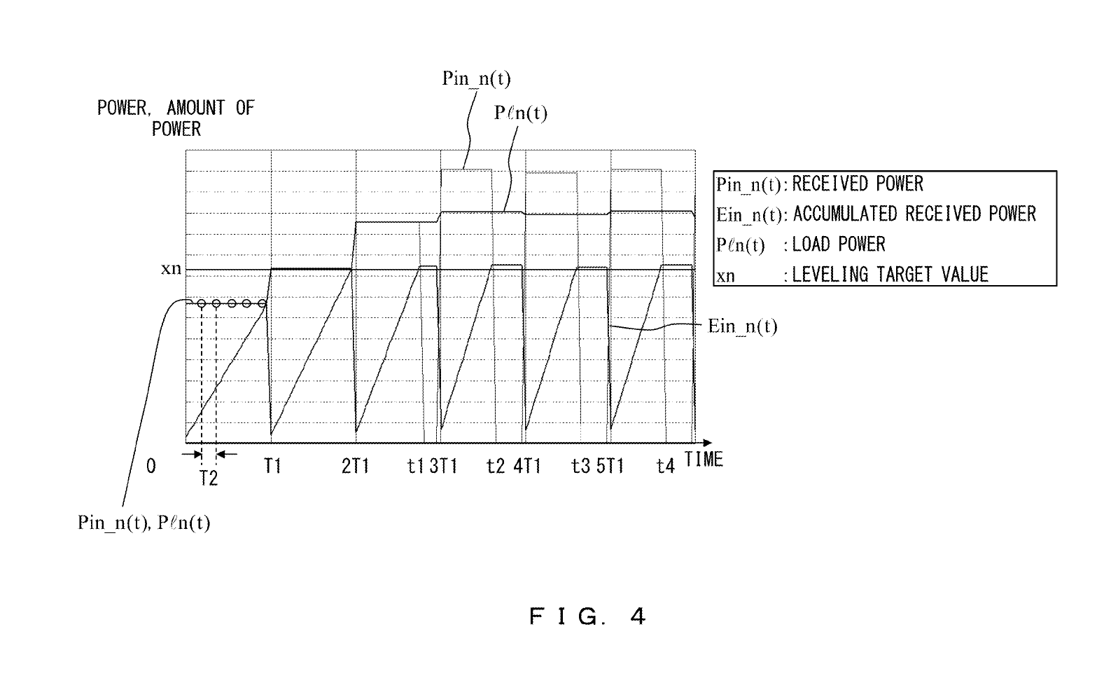

FIG. 4 illustrates an example of the power leveling control, where a vertical axis indicates power and the amount of power and a horizontal axis indicates time. As an example, in the power leveling control, the total amount of power received from the power supply 3 during a predetermined demand time period T1 is measured, and the receiving of power from the power supply 3 is controlled according to the comparison between the measured total amount of power and a leveling target value. In the embodiment, the received power measurement unit 9-n measures, as received power Pin_n(t) from the power supply 3, the sum of the power consumption of the varying load 13-n and the power accumulated in the electric cell 11-n.

Next, with reference to FIG. 4, descriptions will be given of an example in which the switch 5 is opened or closed in accordance with whether the accumulated received power Ein_n(t), i.e., the sum of the received power Pin_n(t) from the power supply 3, exceeds a certain leveling target value xn at a certain time point of the demand time period T1. FIG. 4 depicts temporal changes in received power Pin_n(t), accumulated received power Ein_n(t), and load power Pln_n(t). The received power Pin_n(t) is measured by the received power measurement unit 9-n every time the period of monitoring time T2 elapses. The accumulated received power Ein_n(t) is the amount of power accumulated since the start of the demand time period T1 on the assumption that the received power Pin_n(t) measured by the received power measurement unit 9-n has continued for the period of monitoring time T2. The load power Pln(t) is the power consumed by the varying load 13-n.

As depicted in FIG. 4, when the power consumed by the varying load 13-n changes as with load power PLn(t), received power Pin_n(t) becomes equal to load power Pln(t) on the assumption that the electric cell is fully charged during the period of time t=0 to t1, i.e., the period up to the moment when accumulated received power Ein_n(t) reaches the leveling target value xn. The accumulated received power Ein_n(t) is the amount of power accumulated during the demand time period T1, and, as long as the load power is constant, assumes a sawtooth wave like shape during the period of time t=0 to 2T1, i.e., the period during which the leveling target value xn is not reached. In the example of FIG. 4, load power Pln(t) increases at around time t=2T1. The increase in the load power Pln(t) leads to an increase in received power Pin_n(t). At time t=t1, the accumulated received power Ein_n(t) exceeds the leveling target value xn, thereby opening the switch 5-n, with the result that the electric cell 11-n starts to discharge power. While the switch 5-n is open, received power Pin_n(t)=0. During time t=t1 to 3T1, the electric cell 11-n discharges power.

At time t=3T1, at which the demand time period shifts to the next one, the accumulated received power Ein_n(t) is reset, closing the switch 5-n again, with the result that the power supply 3 starts to supply power, and power is received during time t=3T to t2. At time t=t2, the accumulated received power Ein_n(t) exceeds the leveling target value xn again, opening the switch 5, and the electric cell 11 starts to discharge power. After this, similar operations are repeated. In this example, since time t=3T1, i.e., after the electric cell 11-n discharges power, the electric cell 11-n is charged, and hence received power Pin_n(t) is the sum of load power Pln(t) and the power with which the electric cell 11-n is charged. In this way, power leveling control is performed wherein the received power amount Ein_n(t) within the demand time period is limited to a value equivalent to the leveling target value xn.

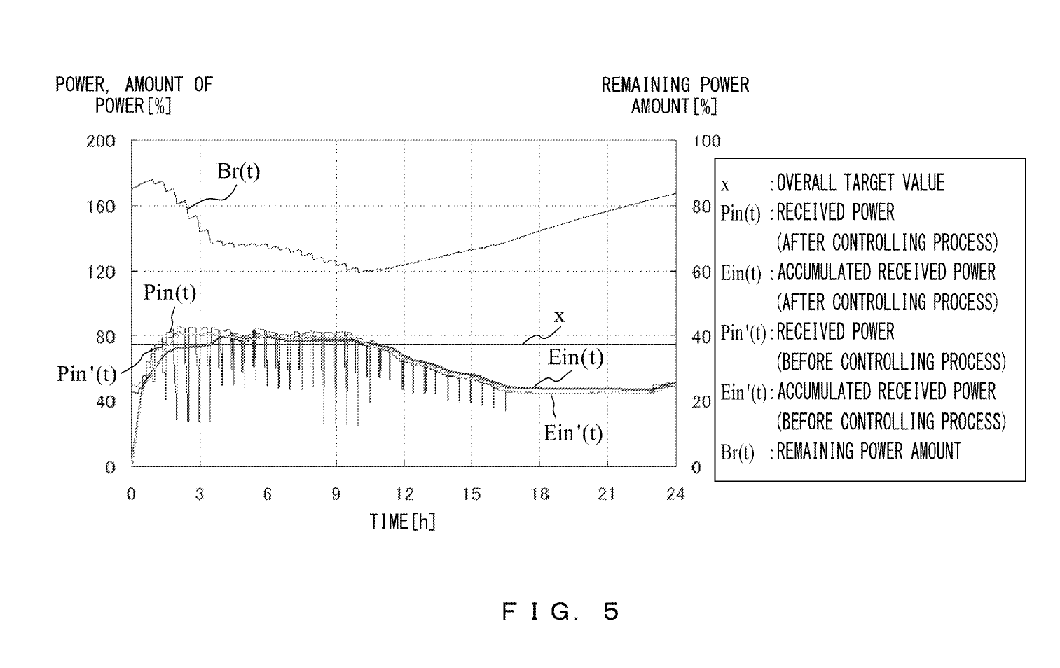

FIG. 5 illustrates the status of the supplying of power and remaining power amounts for a situation in which leveling control is not performed comprehensively for the power centralized control system 1. In FIG. 5, the vertical axis indicates a percentage based on the sum of the maximum power consumptions Lmax(n) of all of the varying loads 13 or a percentage based on the sum of the amounts of the maximum power consumed during the demand time period T1 (e.g., 30 minutes) and a percentage based on the sum of accumulation capacities, and the horizontal axis indicates time. “Leveling control is not performed comprehensively for the power centralized control system 1” means that the overall target value x of the power centralized control system 1 is evenly divided into individual target values xn of the demand units 15 and, regardless of the remaining power amount of each electric cell 11, control is performed using a certain individual target value xn.

In FIG. 5, before noon, received power Pin(t) often becomes equal to or greater than the unit time average power of the overall target value x, and this decreases the total remaining power amount Br(t) of all of the demand units 15. During the time period when received power Pin(t) becomes lower than the unit of time average power of the overall target value x, the remaining power amount Br(t) increases.

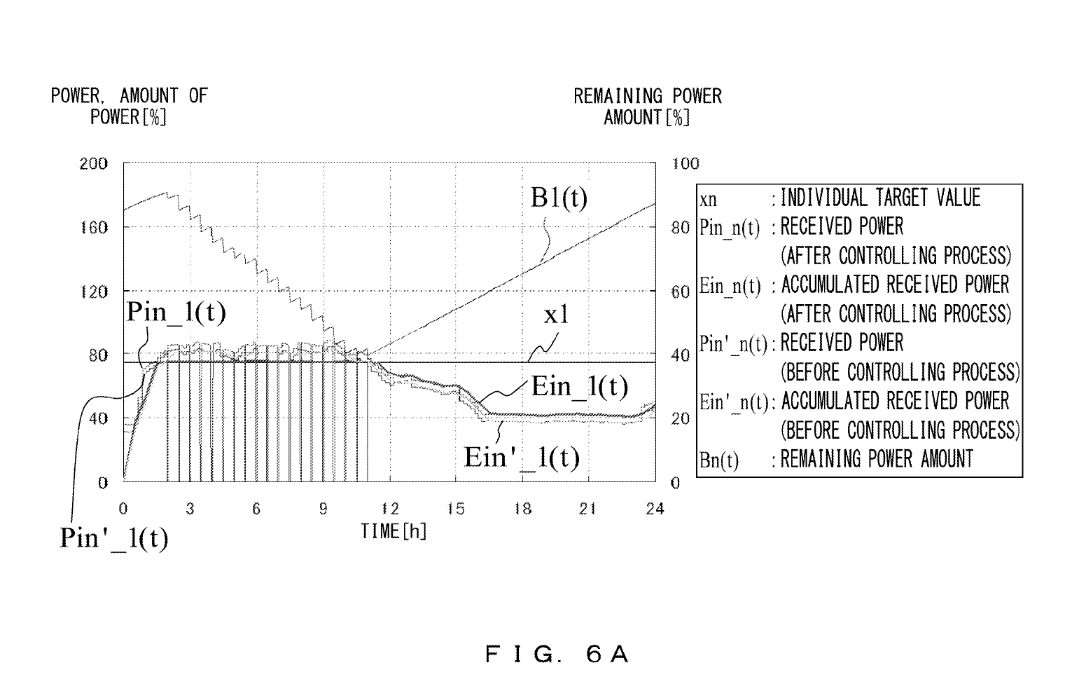

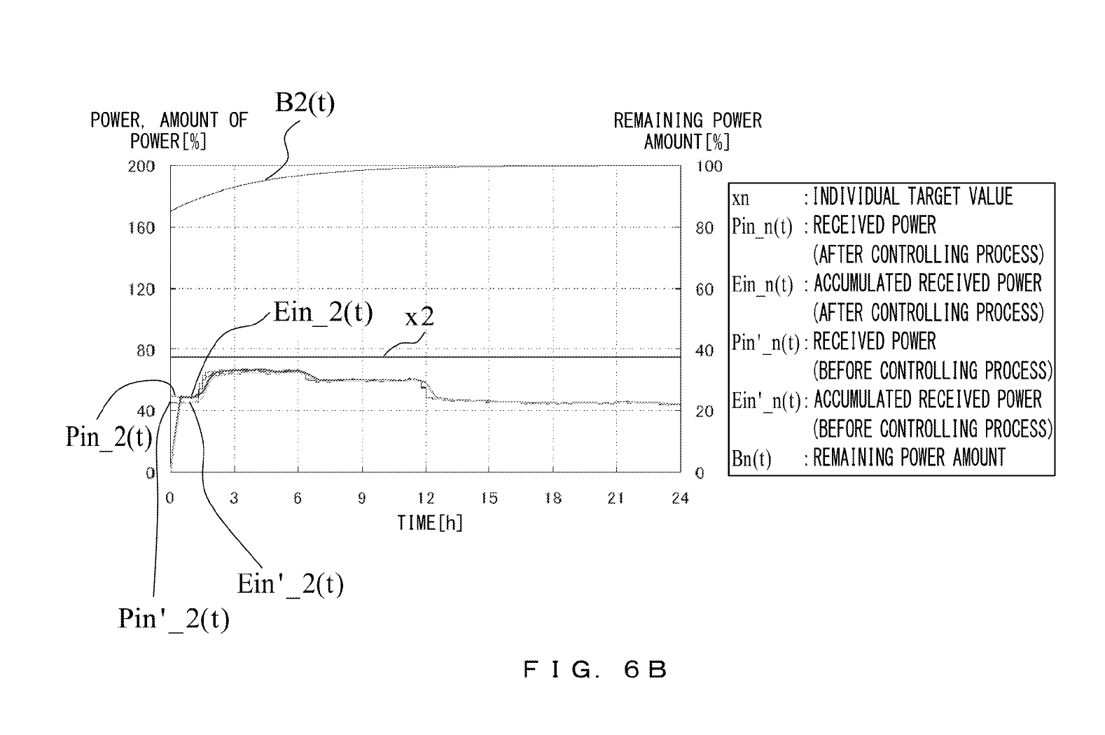

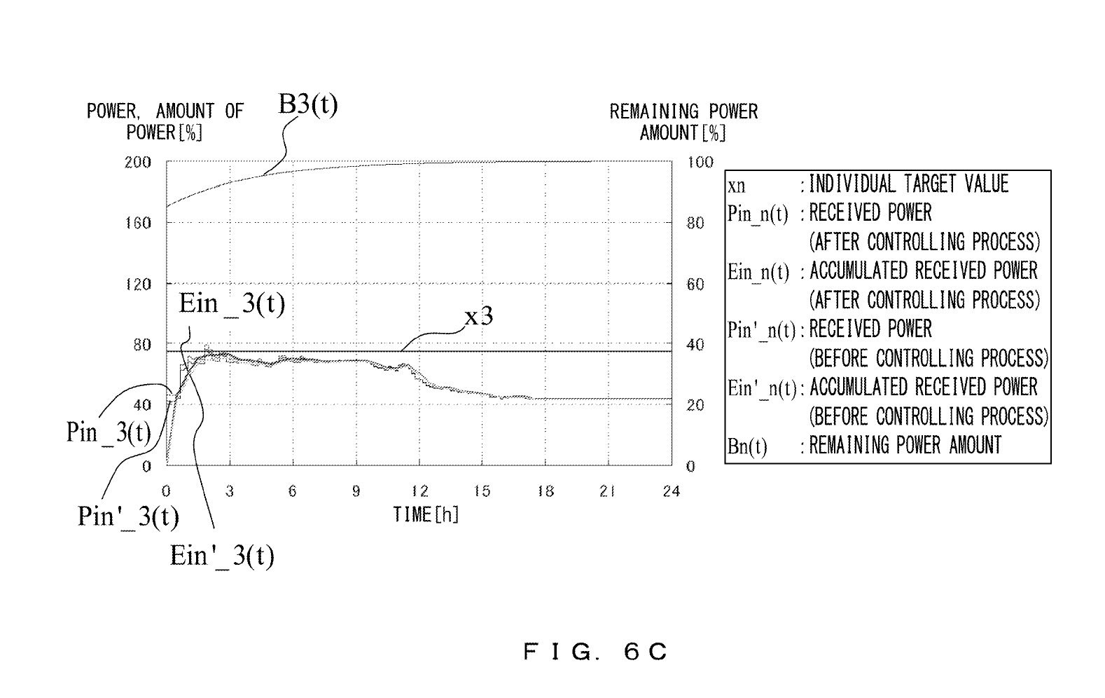

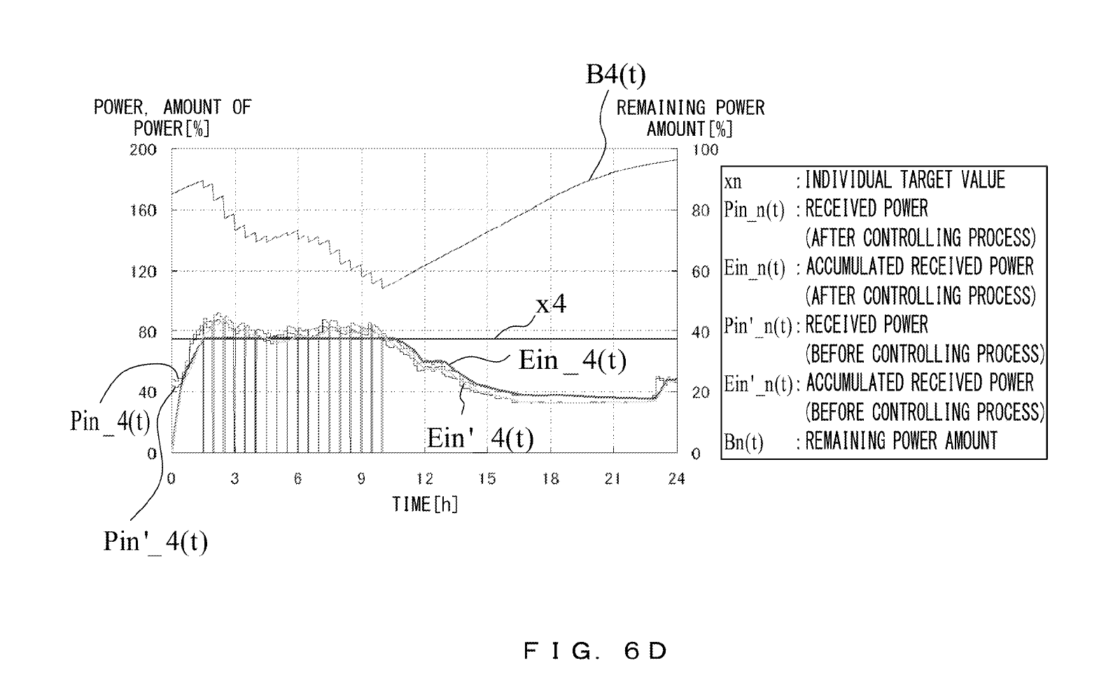

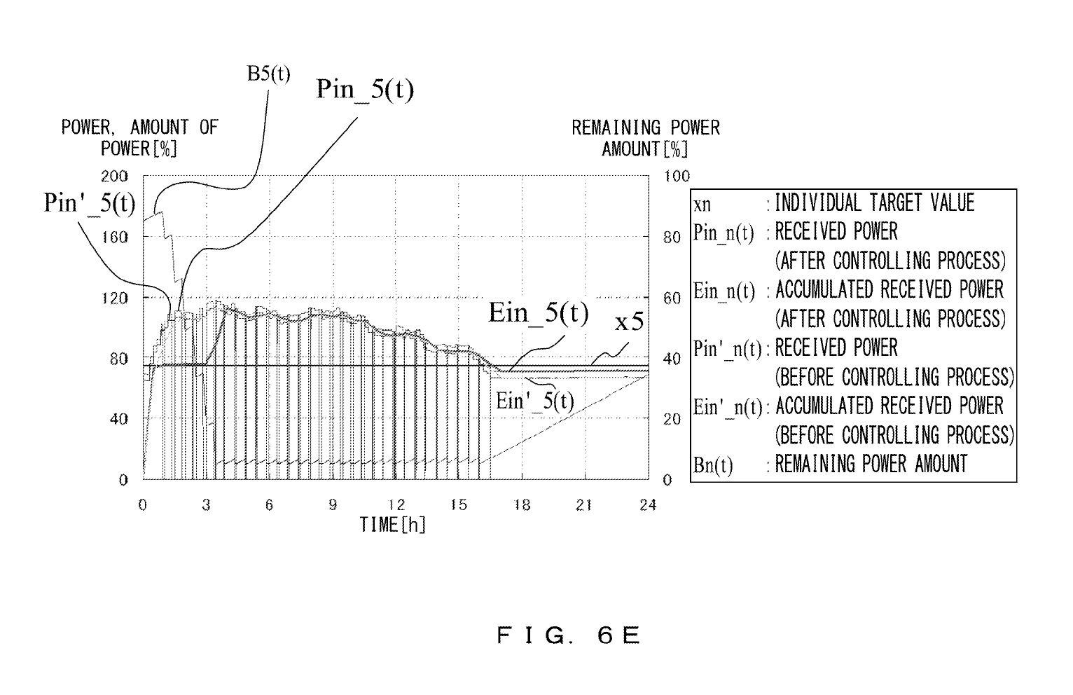

FIGS. 6A-6E each illustrate an exemplary status of the supplying of power and an exemplary change in the remaining power amount for a situation in which leveling control is not performed comprehensively for the power centralized control system 1. FIGS. 6A and 6B respectively depict examples for the demand units 15-1 and 15-2. FIGS. 6C and 6D respectively depict examples for the demand units 15-3 and 15-4. FIG. 6E depicts an example for the demand unit 15-5.

In FIGS. 6A-6E, the vertical axis indicates a percentage based on the maximum power consumption Lmax(n) of a varying load 13 or a percentage based on the amount of the maximum power consumed during the demand time period T1 (e.g., minutes) and a percentage based on the accumulation capacity of a demand unit 15, and the horizontal axis indicates time. FIGS. 6A-6E depict temporal changes in the received power Pin′_n(t) and the accumulated received power Ein_n′(t) obtained before leveling control, and in the received power Pin_n(t), the accumulated received power Ein_n(t), and the remaining power amount Bn(t) obtained as a result of the leveling control according to the individual target value xn.

As depicted in FIG. 6A, before leveling control is performed, received power Pin′_{—}1(t) and the accumulated received power Ein′_{—}1(t) are obtained; after leveling control is performed, received power Pin_{—}1(t) and the accumulated received power Ein_{—}1(t) are obtained, and the remaining power amount of the electric cell 11 is the remaining power amount B1(t). In the example of FIG. 6A, before noon, received power Pin_{—}1(t) indicates high values relative to the unit of time average power of the individual target value x1, and the accumulated received power Ein_{—}1(t) often reaches the individual target value x1, thereby decreasing the remaining power amount B1, which increases afterward. In the example of FIG. 6B, received power Pin_{—}2(t) indicates low values relative to the unit of time average power of the individual target value x2, and the accumulated received power amount Ein_{—}2(t) does not reach the individual target value x2, with the result that the electric cell 11 is always almost fully charged.

In the example of FIG. 6C, received power Pin_{—}3(t) indicates low values relative to the unit of time average power of the individual target value x3, and the accumulated received power amount Ein_{—}3(t) does not reach the individual target value x3, with the result that the electric cell 11 is always almost fully charged. In the example of FIG. 6D, before noon, received power Pin_{—}4(t) indicates high values relative to the unit of time average power of the individual target value x4, and the accumulated received power Ein_{—}4(t) often reaches the individual target value x4, thereby decreasing the remaining power amount B4, which increases afterward.

In the example of FIG. 6E, until after 4:00 p.m., received power Pin(5) indicates high values relative to the unit of time average power of the individual target value x5. Before 3:00 a.m., the accumulated received power Ein_{—}5(t) often reaches the individual target value X5, thereby decreasing the remaining power amount B5(t), and, after 3:00 a.m., the remaining power amount B5(t) of the electric cell 11 becomes almost 0. Afterward, received power Pin5(t) continuously indicates high values relative to the unit of time average power of the individual target value x5, and, since no power remains in the electric cell 11, the accumulated received power Ein_{—}5(t) exceeds the individual target value x5 until after 4:00 p.m. Afterward, the remaining power amount B5(t) starts to increase when received power Pin_{—}5(t) becomes less than the unit of time average power of the individual target value x5.

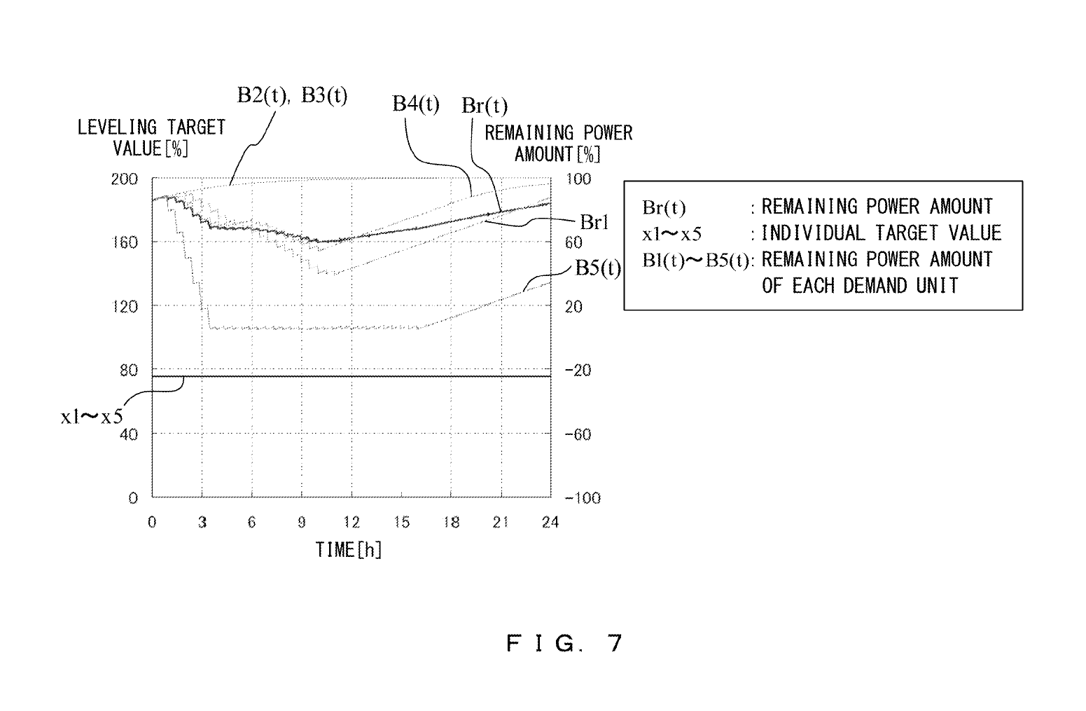

FIG. 7 depicts a remaining power amount Br(t), remaining power amounts Bn(t), an overall target value x, and an individual target value xn for a situation in which leveling control is not performed comprehensively for the power centralized control system, as described above. In FIG. 7, the vertical axis indicates a percentage based on the amount of the maximum power consumed by each demand unit 15 and a percentage based on the accumulation capacity of each demand unit 15 or the total accumulation capacity of all of the demand units 15, and the horizontal axis indicates time. As described above with reference to FIGS. 6A-6E, from 12:00 a.m. to 12:00 p.m., the remaining power amounts Bn(t) indicate various trends. That is, in addition to a trend suitable for performing leveling control (i.e., a trend wherein the electric cells discharge power during the time periods with large power consumption, thereby decreasing the remaining power amounts, and the electric cells are charged during the time periods with small power consumption, thereby increasing the remaining power amounts), there are, for example, a trend wherein a saturation state is achieved due to increased power and a trend wherein power decreases and the electric cell becomes empty.

As described above, performing leveling control of the demand units 15 of the power centralized control system 1 using the equal individual target value xn forms the impression that the power centralized control system 1 is generally controlled in a preferable manner, as depicted in FIG. 5. However, in terms of the individual demand units 15, remaining power amount Bn(t) becomes saturated or is used up. Hence, while one demand unit has a surplus amount of power, another demand unit does not have a sufficient amount of power, thereby increasing the maximum received power amount. This indicates that the remaining power amounts and the accumulation capacities of all of the electric cells 11 are being insufficiently utilized.

The following will describe a method for determining an individual target value in accordance with the first embodiment. In the first embodiment, the leveling target value of each demand unit 15 for time t is indicated as an individual target value xn(t) (n is an integer from 1 to N and is a variable corresponding to each demand unit 15). The individual target determining unit 30 allocates the overall target value x among the demand units 15 in a manner such that sum of the amounts of power corresponding to the individual target values xn(t) is equal to the total amount of power corresponds to the overall target value x of the power centralized control system 1. The demand units 15 perform leveling control in accordance with the individual target values xn(t), independently. Under the management of the number managing unit 36, the remaining power amount measurement units 12 periodically collect the remaining power amounts Bn(t) of the demand units 15, where n is an integer from 1 to N and is a variable corresponding to each demand unit 15. “t” indicates a time measured off. The individual target values xn(t) are updated for, for example, each monitoring time T2. The time t, directed to the remaining power amount Bn(t) collected for each demand unit 15, may, in a strict sense, change due to, for example, a delay in processing or communication, but the following descriptions are based on the assumption that the monitoring times T2 related to all of the demand units 15 are completely in synchrony with each other.

According to each of the collected remaining power amounts Bn(t), the individual target determining unit 30 sequentially determines an individual target value xn(t), which is the product of the overall target value x and the reciprocal ratio according to the remaining power amounts Bn(t), as indicated by the following formula, formula 1.

$$xn ( t ) = x \times \frac{\frac{1}{Bn ( t )}}{{\sum }_{k = 1}^{N} \frac{1}{Bk ( t )}} \qquad ( Formula 1 )$$

In formula 1, n indicates a variable corresponding to a demand unit 15; N, the total number of demand units 15; x, the overall target value; xn(t), the individual target value of the demand unit 15 determined at time t; Bn(t), the remaining power amount of the electric cell 11 of the demand unit 15 for time t (percentage based on accumulated power at the time of full charge, i.e., percentage based on an accumulation capacity).

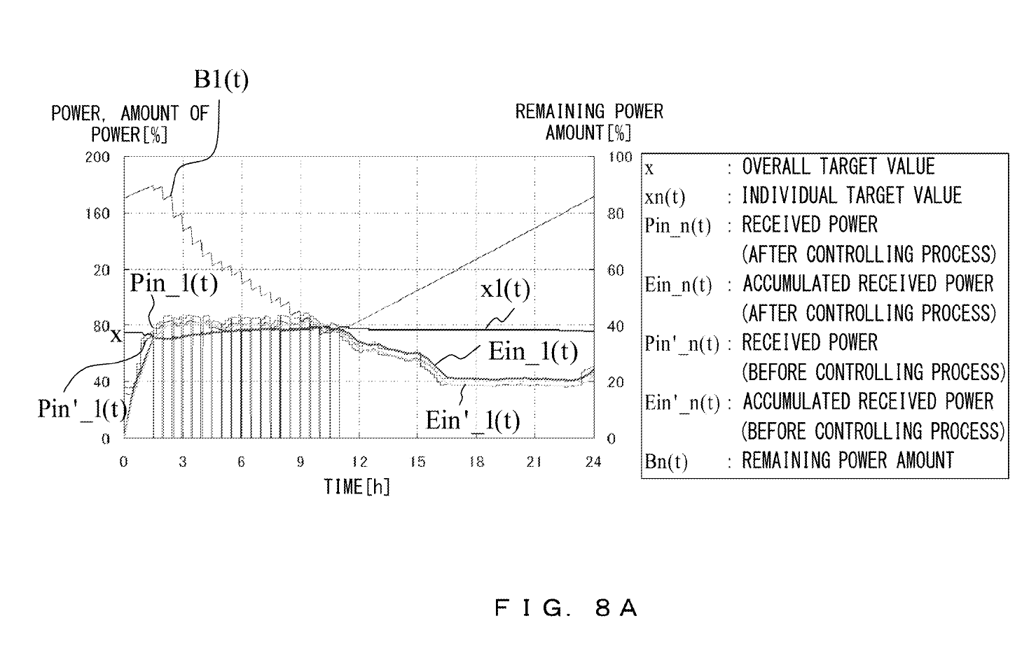

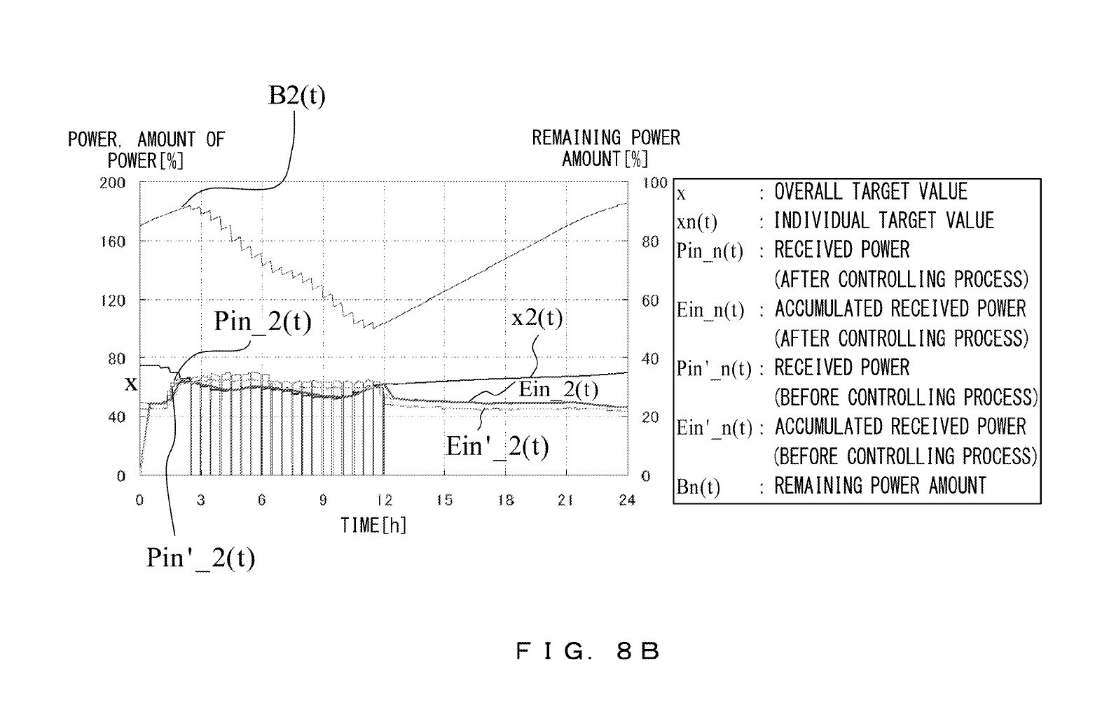

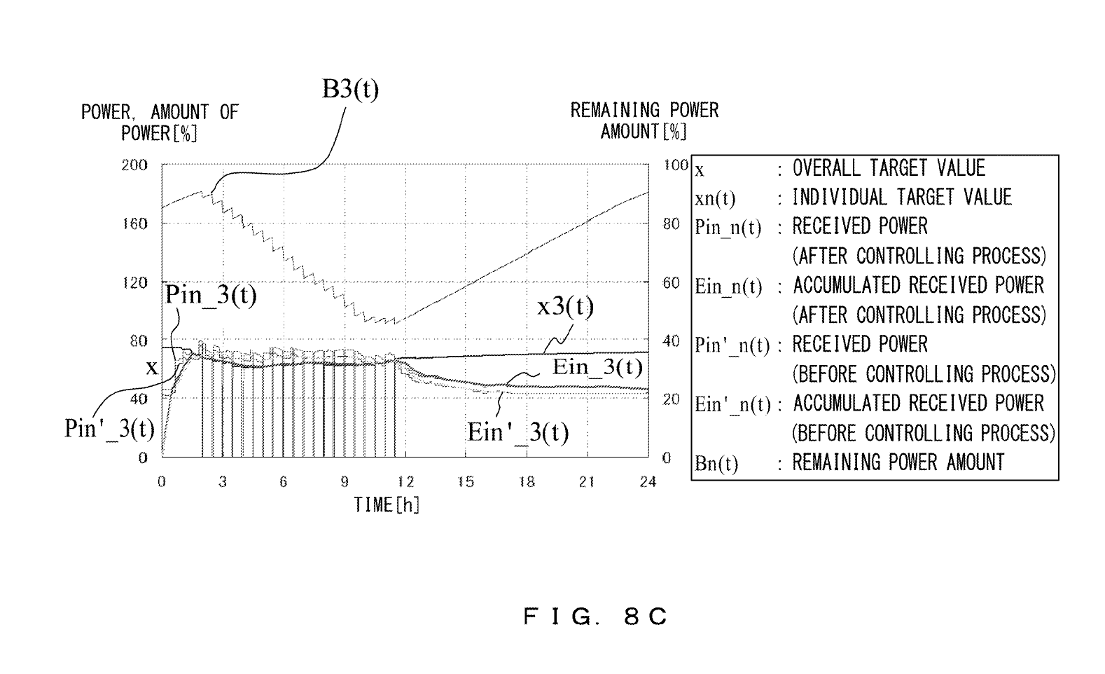

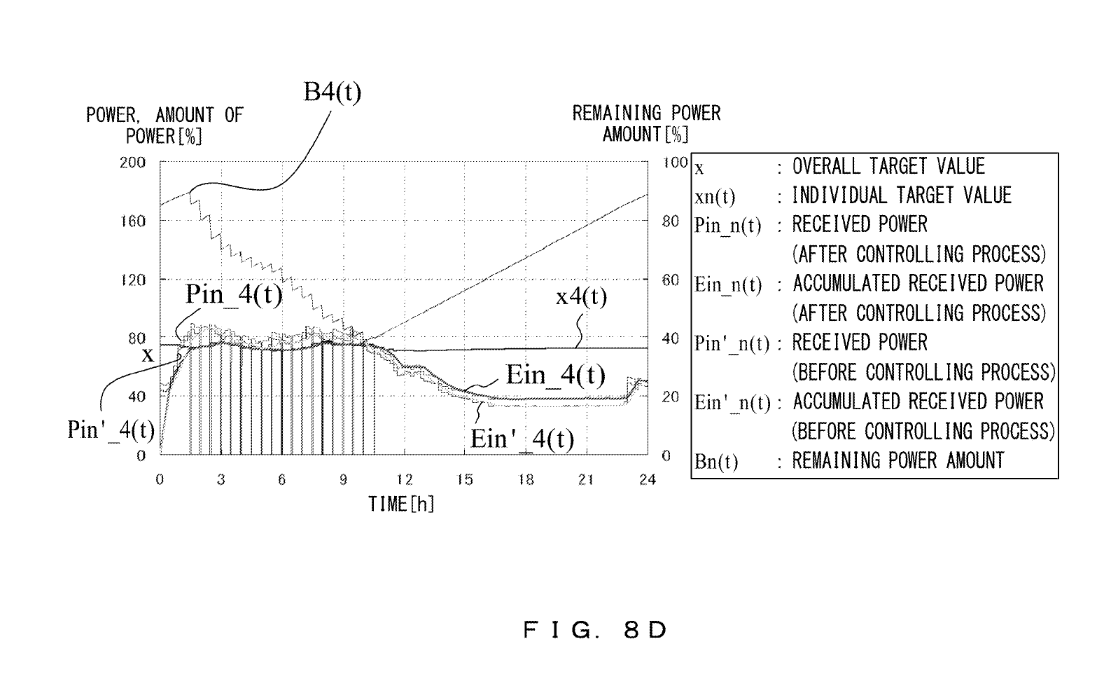

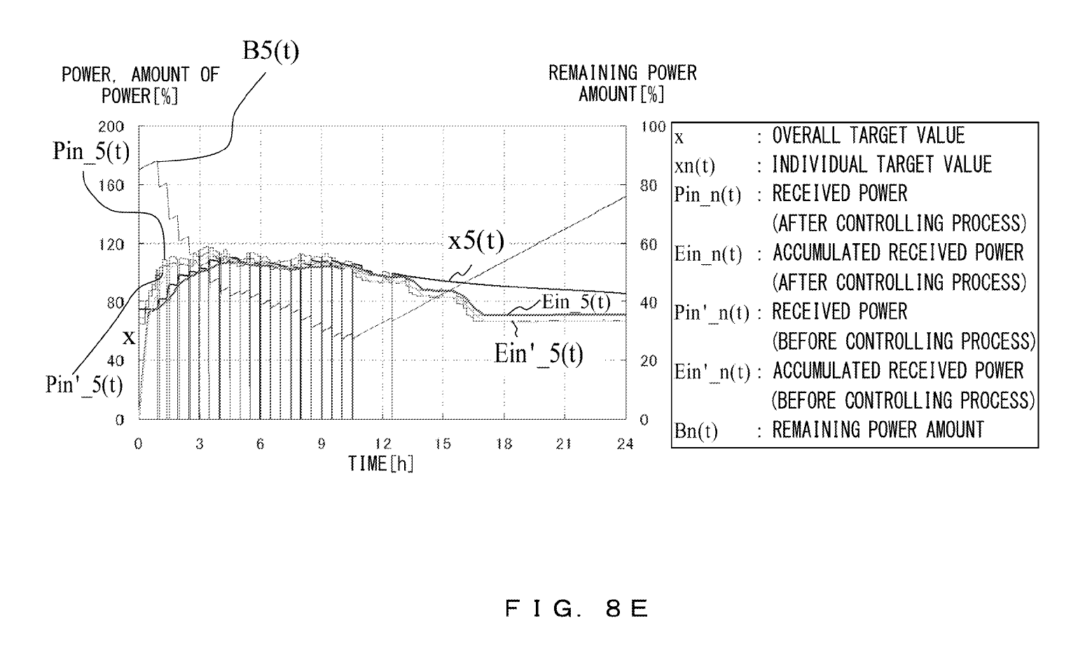

FIGS. 8A-8E each illustrate an exemplary status of the supplying of power and an exemplary change in the remaining power amount of the first demand unit for a situation in which leveling control is performed comprehensively for the power centralized control system 1. FIG. 8A depicts an example for the demand unit 15-1. FIG. 8B depicts an example for the demand unit 15-2. FIG. 8C depicts an example for the demand unit 15-3. FIG. 8D depicts an example for the demand unit 15-4. FIG. 8E depicts an example for the demand unit 15-5.

In FIGS. 8A-8E, the vertical axis indicates a percentage based on the maximum power consumption Lmax(n) of each varying load 13 or a percentage based on the amount of the maximum power consumption and a percentage based on an accumulation capacity, and the horizontal axis indicates time. The drawings express the status of the supplying of power as a percentage for the sake of description, however, as long as values may be substituted in formulas using the same unit, any unit, e.g., Wh, may be used.

FIGS. 8A-8E depict received power Pin′_n(t) and the accumulated received power Ein′_n(t) before leveling control. FIGS. 8A-8E depict temporal changes in the received power Pin_n(t), the accumulated received power Ein_n(t), and the remaining power amount Bn(t) obtained as a result of the comprehensive leveling of the power centralized control system 1, wherein the individual target values xn(t) of the demand units 15-1 to 15-5 of the power centralized control system 1 are sequentially changed. Note that n=1 to 5.

As illustrated in FIG. 8A, which depicts an example for the first demand unit, the status of received power before leveling control indicates received power Pin′_{—}1(t) and the accumulated received power Ein′_{—}1(t). In the case of performing leveling control, the individual target value x1(t) is equal to the overall target value x at time t=0 but is sequentially updated according to formula 1. In this case, the status of the power received by the demand unit 15-1 indicates received power Pin_{—}1(t) and the accumulated received power Ein_{—}1(t), and the remaining power amount indicates the remaining power amount B1(t).

A second demand unit indicated in FIG. 8B includes a varying load 13 that consumes a smaller amount of power than what is indicated in FIG. 1. In this example, the individual target value x2(t) is sequentially updated according to formula 1. As illustrated in FIG. 8B, the status of received power before leveling control indicates received power Pin′_{—}2(t) and the accumulated received power Ein′_{—}2(t). In the case of performing leveling control, the individual target value x2(t) is equal to the overall target value x at time t=0 but is sequentially updated according to formula 1. In this case, the status of the power received by the demand unit 15-2 indicates received power Pin_{—}2(t) and the accumulated received power Ein_{—}2(t), and the remaining power amount indicates the remaining power amount B2(t).

A third demand unit indicated in FIG. 8C includes another varying load 13 that consumes power of an amount equivalent to what is indicated in FIG. 1. In this example, the individual target value x3(t) is sequentially updated according to formula 1. As illustrated in FIG. 8C, the status of received power before leveling control indicates received power Pin′_{—}3(t) and the accumulated received power Ein′_{—}3(t). In the case of performing leveling control, the individual target value x3(t) is equal to the overall target value x at time t=0 but is sequentially updated according to formula 1. In this case, the status of the power received by the demand unit 15-3 indicates received power Pin_{—}3(t) and the accumulated received power Ein_{—}3(t), and the remaining power amount indicates the remaining power amount B3(t).

A fourth demand unit indicated in FIG. 8D includes still another varying load 13 that consumes power of an amount equivalent to what is indicated in FIG. 1. In this example, the individual target value x4(t) is sequentially updated according to formula 1. As illustrated in FIG. 8D, the status of received power before leveling control indicates received power Pin′_{—}4(t) and the accumulated received power Ein′_{—}4(t). In the case of performing leveling control, the individual target value x4(t) is equal to the overall target value x at time t=0 but is sequentially updated according to formula 1. In this case, the status of the power received by the demand unit 15-4 indicates received power Pin_{—}4(t) and the accumulated received power Ein_{—}4(t), and the remaining power amount indicates the remaining power amount B4(t).

A fifth demand unit indicated in FIG. 8E includes a varying load 13 that consumes a smaller amount of power than what is indicated in FIG. 1. In this example, the individual target value x5(t) is sequentially updated according to formula 1. As illustrated in FIG. 8E, the status of received power before leveling control indicates received power Pin′_{—}5(t) and the accumulated received power Ein′_{—}5(t). In the case of performing leveling control, the individual target value x5(t) is equal to the overall target value x at time t=0 but is sequentially updated according to formula 1. In this case, the status of the power received by the demand unit 15-5 indicates received power Pin_{—}5(t) and the accumulated received power Ein_{—}5(t), and the remaining power amount indicates the remaining power amount B5(t).

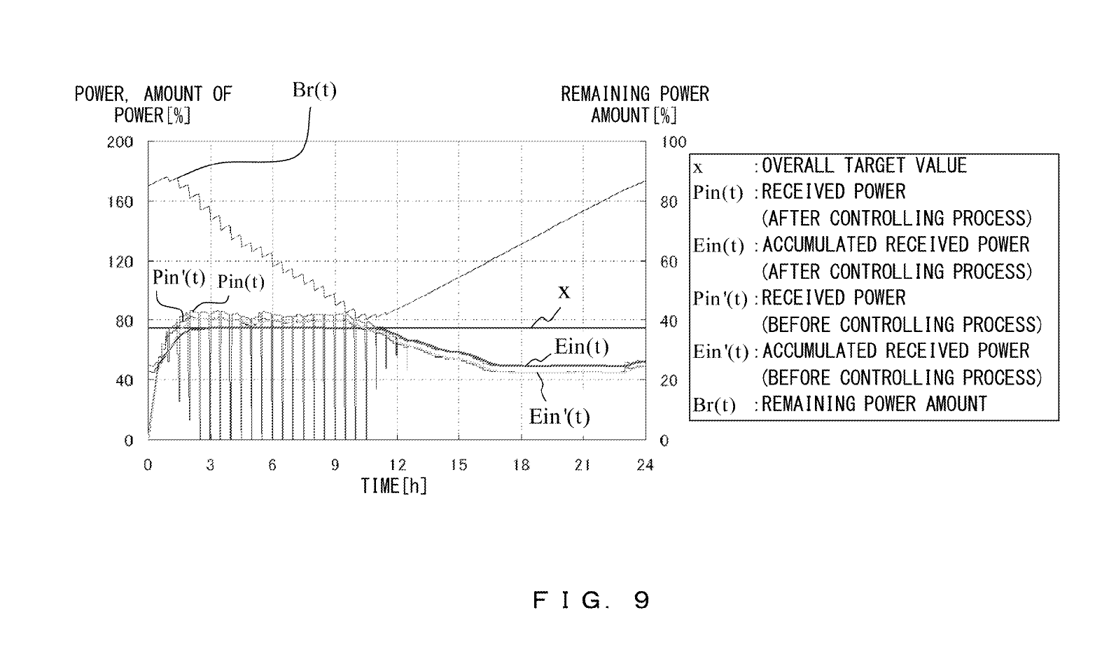

FIG. 9 illustrates the total received power Pin′(t) and the total accumulated received power Ein′(t) of the demand units 15-1 to 15-5 in FIGS. 8A-8E before leveling control; and the total received power Pin(t), the total accumulated received power Ein(t), and the total remaining power amount Br(t) of these demand units after leveling control.

As depicted in FIG. 9, the individual target values x1(t) to x5(t) at that time are divisions of the overall target value x, and the sum thereof is thus the overall target value x (in the percentage notation, the average of the individual target values x1(t) to x5(t) is the overall target value x). The status of the receiving of power before leveling control indicates received power Pin′(t) and the accumulated received power Ein′(t). The status of the receiving of power after leveling control indicates received power Pin(t) and the accumulated received power Ein(t), and the remaining power amount after leveling control indicates the remaining power amount Br(t). Accordingly, control is performed as though all of the demand units 15 were connected to an electric cell 11 having a large capacity within the power centralized control system 1, and proper control is performed without the electric cell 11 being saturated and without power being used up.

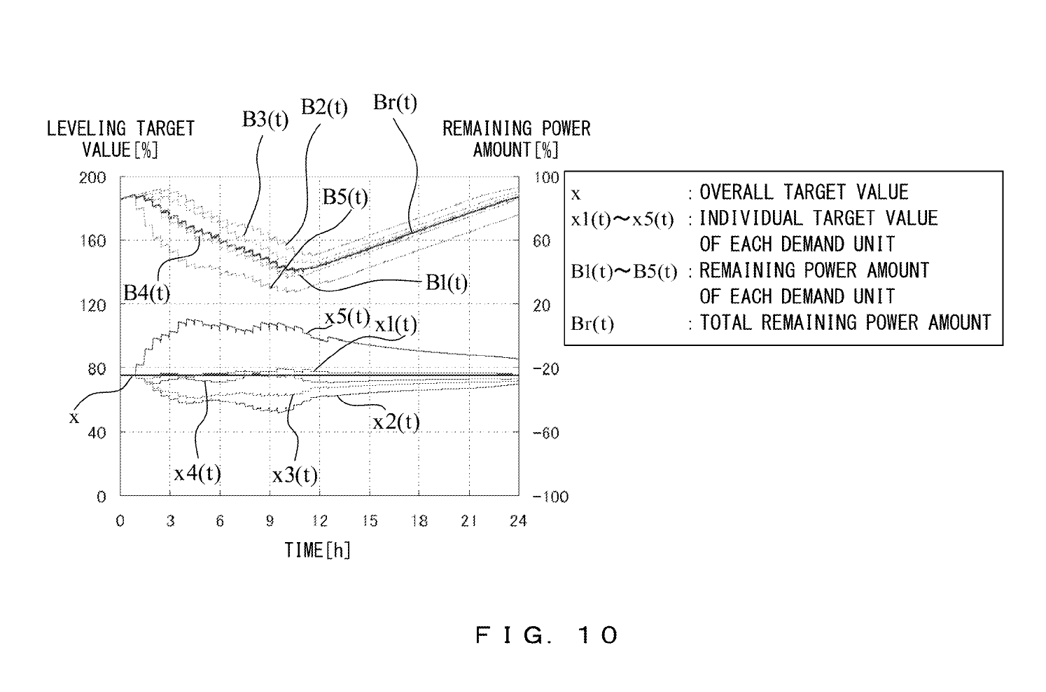

FIG. 10 depicts the overall target value x, the individual target values xn(t) and the remaining power amounts Br(t) of the demand units 15, and the remaining power amount Bn(t) for a situation in which, as described above, leveling control is performed comprehensively for the system. In FIG. 10, the vertical axis indicates a percentage based on the amount of the maximum power consumed by each demand unit 15 or based on the sum of the amounts of the maximum power consumed by all of the demand units 15, or a percentage based on the accumulation capacity of each demand unit 15 or based on the total accumulation capacity of all of the demand units 15. The horizontal axis indicates time.

As depicted in FIG. 10, during the period from 12:00 a.m. to 12:00 p.m., the individual target value xn(t) changes differently for each demand unit. Such a target allocation results in a trend wherein all of the remaining power amounts Bn(t) change similarly to the remaining power amount Br(t), namely, the total remaining power. Accordingly, the power centralized control system 1 indicates small differences in remaining power amounts between the demand units, i.e., the remaining power amount and the accumulation capacity of every electric cell 11 can be effectively utilized, leading to a preferable situation wherein leveling control can be performed more effectively.

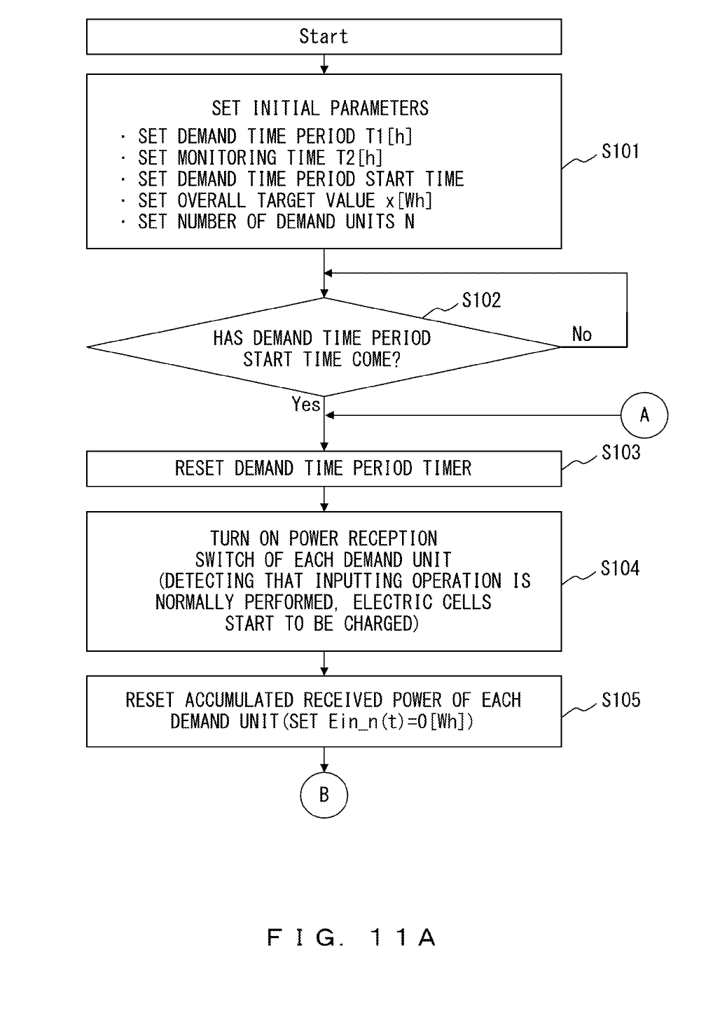

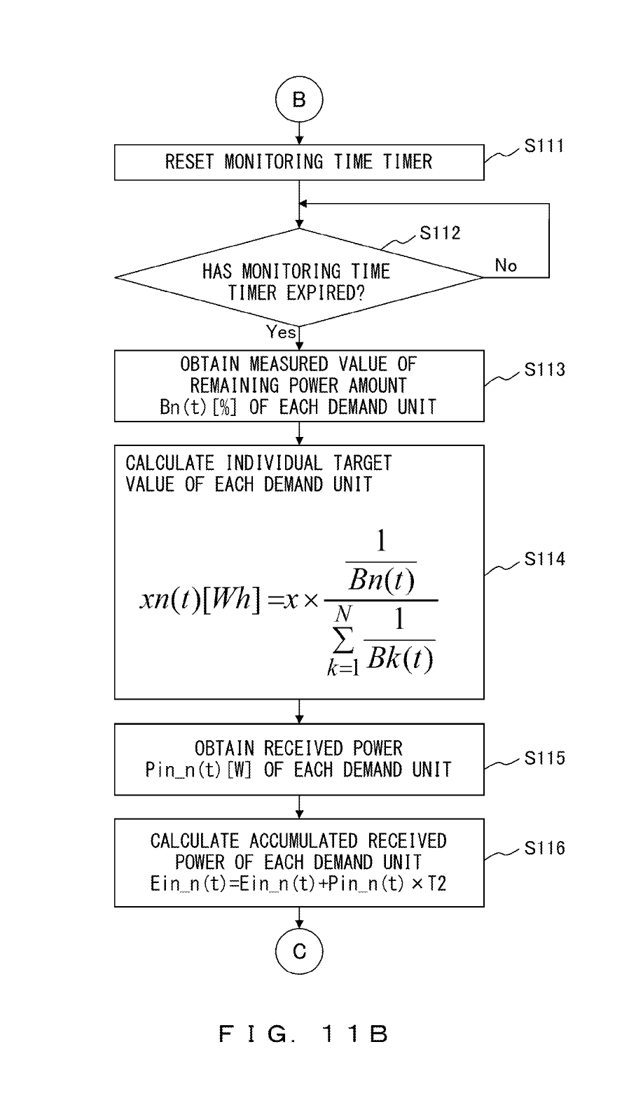

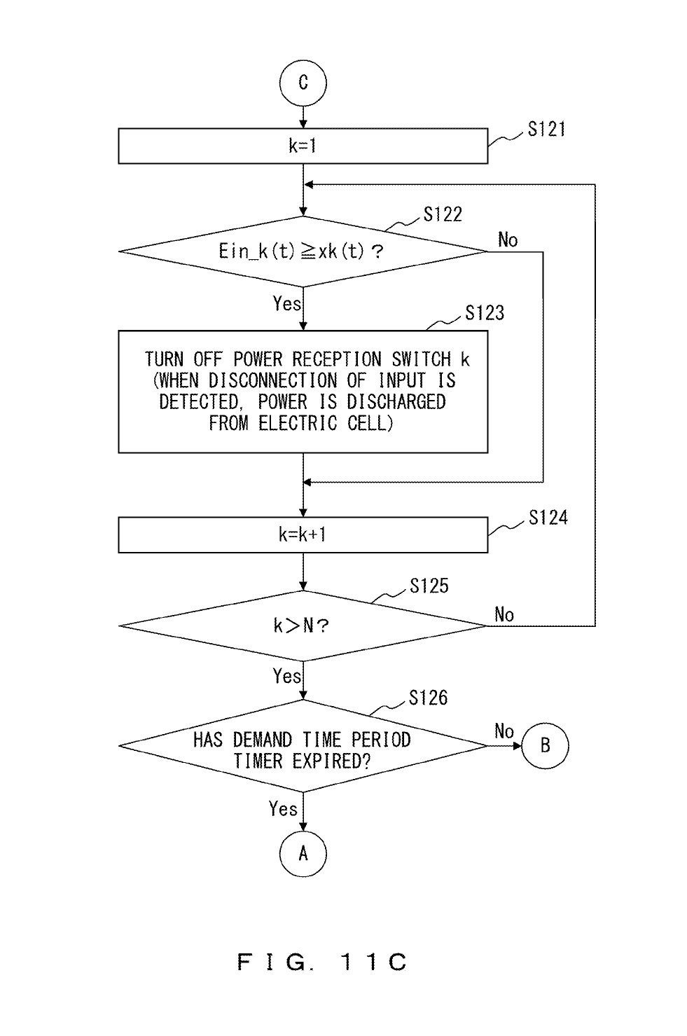

The following will describe operations of the power centralized control system 1 in accordance with the first embodiment with reference to FIGS. 11-13. FIGS. 11-13 are flowcharts illustrating operations of the power centralized control system 1 in accordance with the first embodiment.

As illustrated in FIG. 11A, the leveling controlling unit 20 sets initial parameters for power leveling control in advance. That is, the timer managing unit 38 sets and stores a demand time period T1(h), a monitoring time T2(h), and a demand time period start time in the storage unit 24. The target determining unit 22 sets an overall target value x(Wh) obtained from the overall target storage unit 32. The number managing unit 36 sets a number N that corresponds to the total number of the demand units 15 (S101).

The timer managing unit 38 monitors whether the demand time period start time has come by comparing managed time with the demand time period start time stored by the storage unit 24 (S102: No). At the demand time period start time (S102: Yes), the timer managing unit 38 resets a demand time period timer (not illustrated) (S103).

The switch controlling unit 26 turns on the switch 5 of each demand unit 15. In this case, detecting that an inputting operation has been performed normally, the electric cells 11 start to be charged (S104). The switch controlling unit 26 performs a resetting process for each demand unit 15, resulting in accumulated received power Ein_n(t)=0 (Wh) (S105).

The flow shifts to processes in FIG. 11B. The timer managing unit 38 resets a monitoring time timer (not illustrated) (S111). The timer managing unit 38 repeats a monitoring process until the monitoring time timer expires, i.e., until the monitoring time T2 elapses (S112: No). When the timer managing unit 38 determines that the monitoring time timer has elapsed (S112: Yes), the individual target determining unit 30 obtains the remaining power amounts Bn(t) remaining at time t for the demand units 15-n via the remaining power amount measurement units 12 (S113). The obtained remaining power amounts Bn(t) are expressed as ratios relative to the accumulation capacities of the electric cells 11.

The individual target determining unit 30 calculates an individual target value xn(t) for each demand unit 15 in accordance with formula 1 (S114). The switch controlling unit 26 obtains the received power Pin_n(t) (Wh) of each demand unit 15 via the received power measurement unit 9 (S115) and calculates accumulated received power Ein_n(t)=Ein_n(t)+Pin_n(t)×T2 for the demand unit 15-n (S116).

The flow shifts to processes in FIG. 11C. The switch controlling unit 26 sets k=1 (S121). The switch controlling unit 26 determines whether Ein_k(t)≧xk(t) is satisfied (S122). When Ein_k(t)<xk(t) (S122: No), the switch controlling unit 26 shifts the flow to S124. When Ein_k(t)≧xk(t) (S122: Yes), the switch controlling unit 26 turns off the switch 5 of the demand unit 15-k (power reception switch k) (S123). Detecting the disconnection of a commercial power supply caused by the inactivation of the switch 5, the power storage device 7 discharges power from the electric cell 11.

The switch controlling unit 26 sets k=k+1 (S124) and determines whether k>N is satisfied (S125). When k≦N (S125: No), the switch controlling unit 26 returns the flow to S122. When k>N (S125: Yes), the timer managing unit 38 determines whether the demand time period timer has expired (S126). When it is determined that the demand time period timer has not expired (S126: No), the flow returns to S111 in FIG. 11B; when it is determined that the demand time period timer has expired (S126: Yes), the flow returns to S103 in FIG. 11A.

As described above, the power centralized control system 1 in accordance with the first embodiment allocates individual target values xn(t) to the plurality of demand units 15 connected to the power supply 3 according to the overall target value x. Each demand unit 15 independently performs leveling control according to the individual target value xn(t). The individual target value xn(t) of each demand unit 15 is allocated according to the ratio between the reciprocal of the remaining power amount Bn(t) of the demand unit 15 and the sum of the reciprocals of the remaining power amounts Bn(t) of all of the demand units 15. Accordingly, when the remaining power amount Bn(t) of a demand unit 15 is smaller than that of another demand unit 15, an individual target value xn(t) that is lower than that of the latter demand unit 15 is allocated to the former demand unit 15.

As described above, in the power centralized control system 1 in accordance with the first embodiment, a demand unit 15, namely, a set of a load 13 and a power storage device 7, can independently perform leveling control in accordance with an individual target value xn(t). The individual target values xn(t) are calculated according to the reciprocals of the remaining power amounts Bn(t) of all of the electric cells 11 periodically collected for, for example, each monitoring time T2. Hence, a demand unit 15 with a larger remaining power amount Bn(t) has a lower individual target value xn(t), leading to more opportunities to discharge power; a demand unit 15 with a smaller remaining power amount Bn(t) has a higher individual target value xn(t), leading to more opportunities to be charged. Consequently, the remaining power amounts Bn(t) are equalized. Accordingly, the power centralized control system 1 is operated efficiently, thereby providing advantageous effects such as decreased electricity charges, downsized power storage devices 7, and decreased CO₂ emissions.

In terms of the overall power centralized control system 1, a power leveling originated advantageous effect is obtained wherein, when the varying loads 13 need a large amount of power, the peak of the amount of power received from the power supply 3 per unit time is decreased by discharging the power storage devices 7, rather than receiving power from the power supply 3. In this case, as in the case of, for example, a system wherein all varying loads 13 are connected to one power storage device having a large capacity, all of the remaining power amounts can be effectively utilized, and the total power can be leveled. One possible way to achieve the power centralized control system 1 is, for example, to provide a small capacity power storage device for each power consuming load or for each room. Using small capacity power storage devices 7 located at dispersed sites in this manner may eliminate the need for a large capacity electric cell.

In addition, the power centralized control system 1 in accordance with the embodiment may eliminate the need for inverse load flow to a power system, e.g., the need for direct migration of power between demand units 15, thereby providing the advantageous effects of eliminating the need to perform a complicated controlling process, and suppressing an occurrence of, for example, an accident that would be caused by an improper controlling process. Accordingly, centralized control may be performed on the power storage devices 7 located at dispersed sites without power being migrated directly between the power storage devices 7, and power can be virtually migrated between the power storage devices 7. Hence, centralized controlling will be performed in such a way as to prevent a situation wherein one power storage device 7, from among the power storage devices 7 located at dispersed sites, has insufficient power while another power storage device 7 has sufficient power, allowing the accumulation capacity to be effectively utilized.

An individual target value xn(t) may be determined by measuring a remaining power amount Bn(t). The amount of demand power does not need to be estimated for every varying load 13, and charged power or discharged power does not need to be detected, thereby enabling the individual target value xn(t) to be easily determined. Hence, the accuracy of estimation of a load that fluctuates day by day does not affect the individual target value xn(t), the advantageous effect of leveling is not decreased, and equipment cost or computation process cost is not needed. The measured remaining power amount Bn(t) may be in a ratio to the accumulation capacity of each power accumulation machine 11, and measured values obtained as a ratio do not need to be converted into power or the amount of power.

### Variation of First Embodiment

The following will describe a power centralized control system 1 in accordance with a variation of the first embodiment. Configurations and operations in the variation similar to those of the power centralized control system 1 in accordance with the first embodiment are not described herein.

In the variation, the configuration of the power centralized control system 1 and the processes in leveling control are substantially the same as those in the first embodiment. In the first embodiment, in the calculating of the remaining power amount Bn(t) of a electric cell 11, a ratio to the accumulation capacity is measured, and the measured value is directly used; in the variation, the measured ratio is converted into an accumulated power amount (Wh) to calculate an individual target value xn(t). As in the case of the power centralized control system 1 in accordance with the first embodiment, formula 1 is used to calculate the individual target value xn(t).

In the variation, the amounts of power that need to be charged differ in accordance with the accumulation capacities of the electric cells 11 even when the remaining power amounts Bn(t) indicate the same ratio. However, calculating all of the individual target values xn(t) as the amounts of power can provide individual target values xn(t) that are more suitable for the status of the power of the power centralized control system 1.

### Second Embodiment

The following will describe a power centralized control system 1 in accordance with a second embodiment. Descriptions are not given herein of configurations and operations in the power centralized control system 1 in accordance with the second embodiment that are similar to those in the power centralized control system 1 in accordance with the first embodiment. The configuration of the power centralized control system 1 in accordance with the second embodiment is similar to that of the power centralized control system 1 in accordance with the first embodiment.

In the power centralized control system 1 in accordance with the second embodiment, under a condition in which the demand units 15 each include a varying load 13 with different power consumption, even with identical remaining power amounts Bn(t) and identical individual target values xn(t), the degrees of decrease in the remaining power amounts Bn(t) differ in accordance with power consumptions of the varying loads 13. Accordingly, the ratio between the maximum power consumptions of the loads 13 is viewed as the ratio between the power consumptions of the loads, and, in consideration of not only the remaining power amounts but also the ratio between the maximum power consumptions, an individual target value is determined as indicated by the following formula, formula 2.

$$xn ( t ) = x \times \frac{\frac{1}{Bn ( t )}}{{\sum }_{k = 1}^{N} \frac{1}{Bk ( t )}} \times \frac{L max ( n )}{{\sum }_{k = 1}^{N} L max ( k )} \times α \qquad ( Formula 2 )$$

The following formula, formula 3, holds because the overall target value x is allocated among all of the demand units 15.

$${\sum }_{k = 1}^{N} xk ( t ) = x \qquad ( Formula 3 )$$

Formulas 2 and 3 lead to the following formula, formula 4.

$$xn ( t ) = x \times \frac{\frac{L max ( n )}{Bn ( t )}}{{\sum }_{k = 1}^{N} \frac{L max ( k )}{Bk ( t )}} \qquad ( Formula 4 )$$

In formula 4, n indicates a variable corresponding to each demand unit 15; N, the total number of demand units 15; x, the overall target value; xn(t), the individual target value of each demand unit 15 determined at time t; Bn(t), the remaining power amount of the electric cell 11 of each demand unit 15 for time t. In this case, the remaining power amount may be expressed as a percentage based on the accumulated power amount at the time of a full charge of the electric cell 11, i.e., a percentage based on an accumulation capacity, or may be a value converted into an accumulated power amount (Wh). Lmax (n) indicates the maximum power consumed by each varying load 13, and a indicates a coefficient for normalization.

As described above, the individual target determining unit 30 may continuously collect the amounts of power remaining in the power storage devices 7 of the demand units 15, or may periodically collect the amounts for each monitoring time T2. In accordance with formula 4, the individual target determining unit 30 sequentially determines individual target values xn(t) as values that are proportional to the overall target value x and to the product of the reciprocal ratio between and a remaining power amount Bn(t) and the ratio between the maximum power consumptions Lmax (n) of the loads.

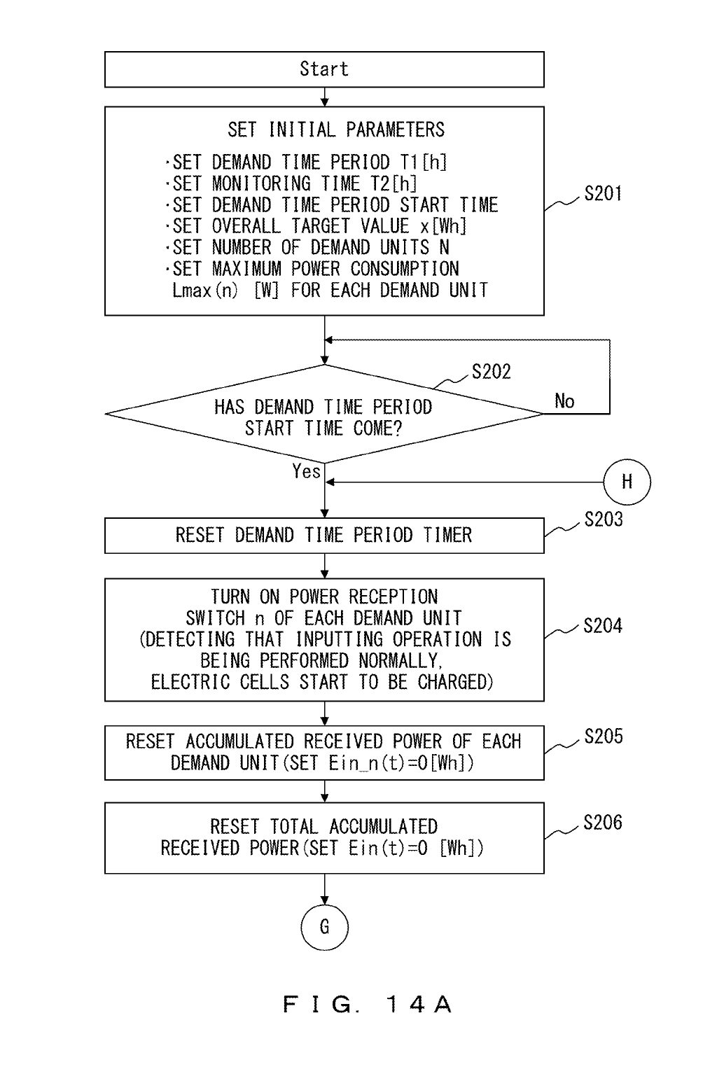

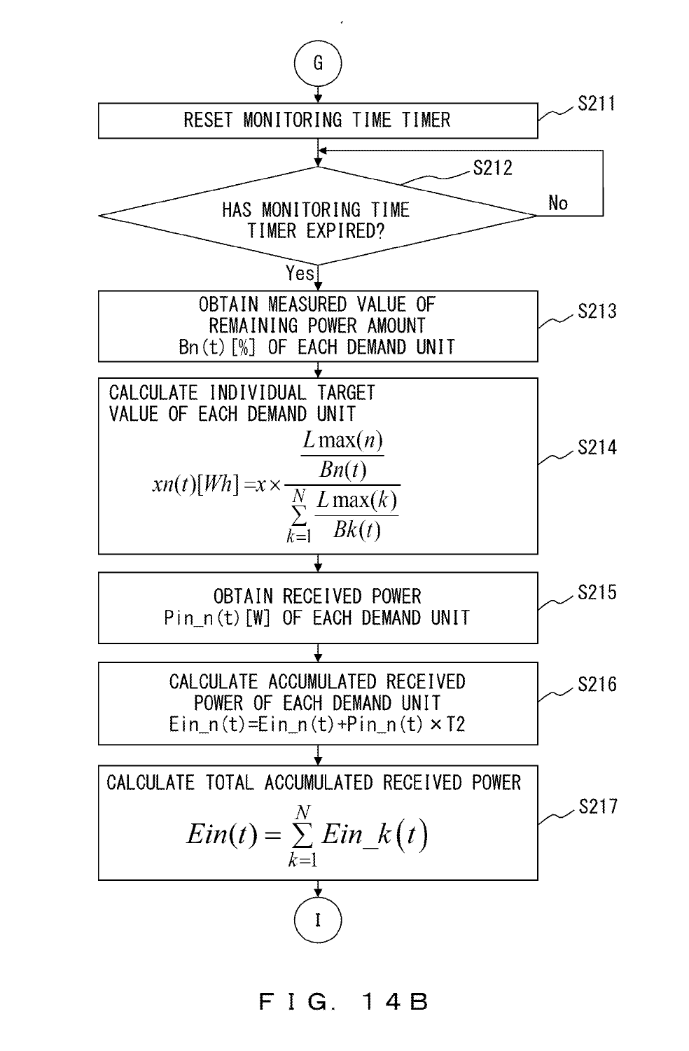

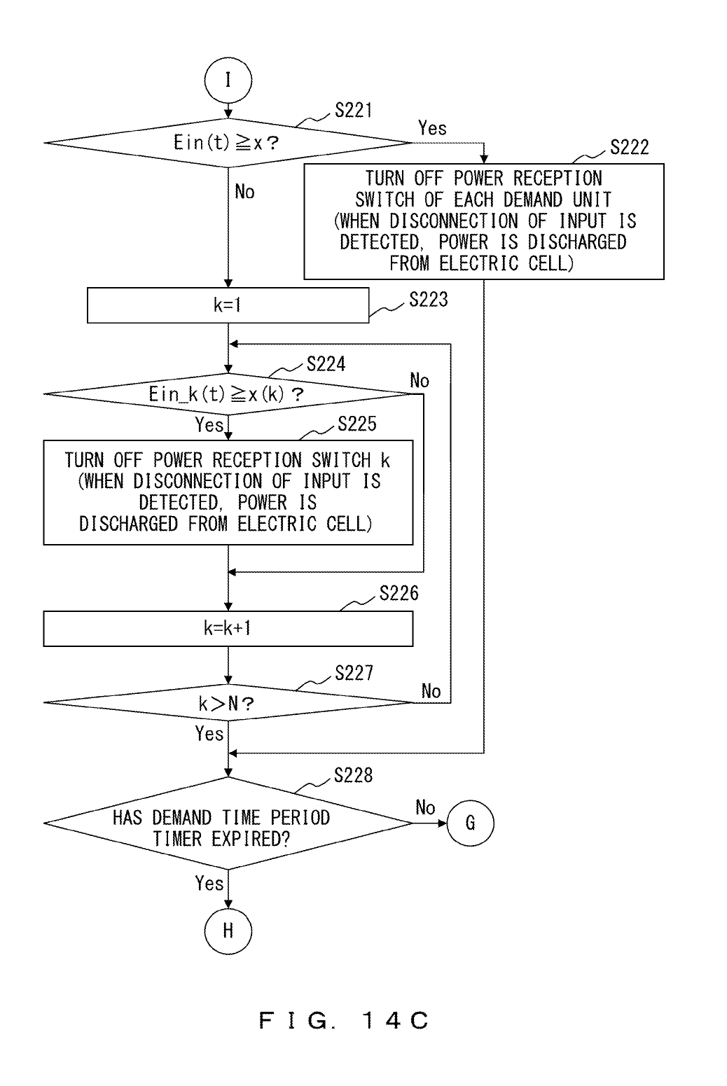

The following will describe operations of the power centralized control system 1 in accordance with the second embodiment with reference to FIGS. 14-16. FIGS. 14-16 are flowcharts illustrating operations of the power centralized control system 1 in accordance with the second embodiment.

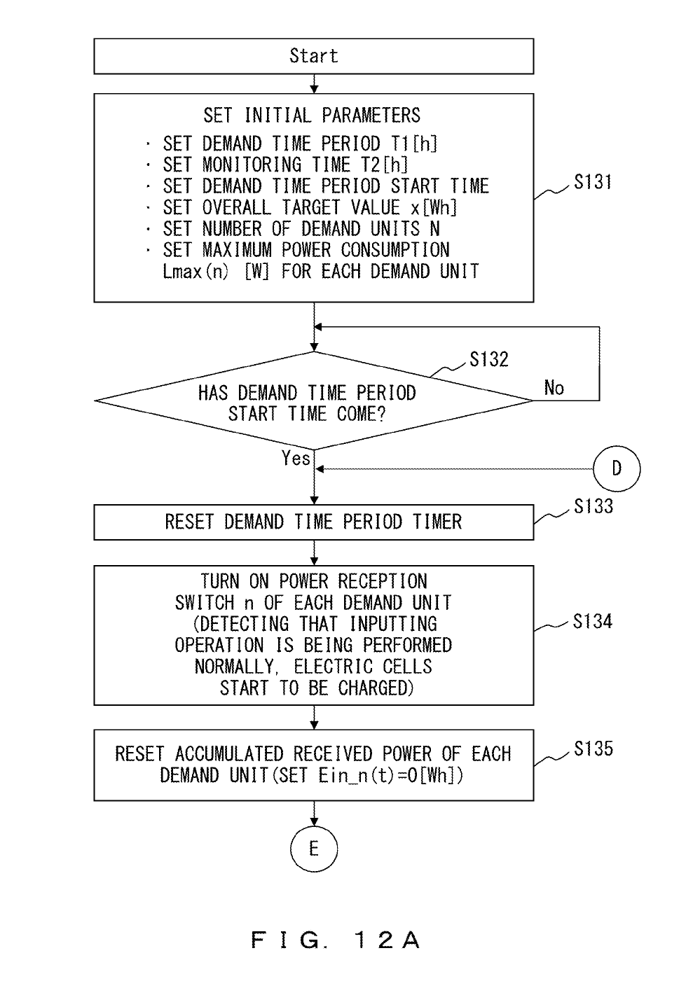

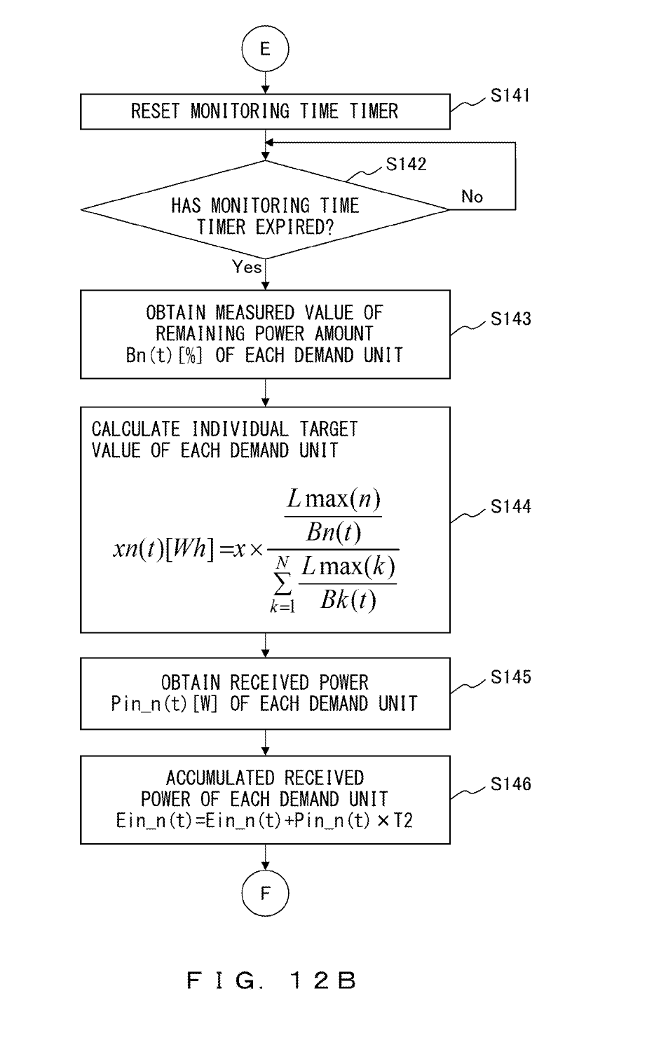

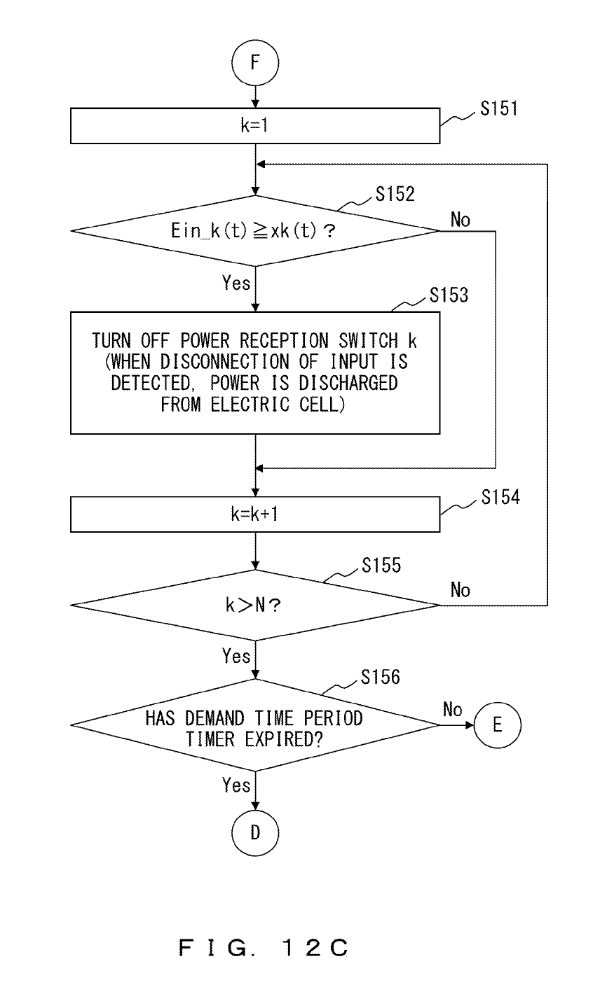

As illustrated in FIG. 12A, the leveling controlling unit 20 sets initial parameters for power leveling control in advance. That is, the timer managing unit 38 sets and stores a demand time period T1(h), a monitoring time T2(h), and a demand time period start time in the storage unit 24. The target determining unit 22 sets an overall target value x (Wh) obtained from the overall target storage unit 32. The number managing unit 36 sets a number N that corresponds to the total number of the demand units 15. In addition, the individual target determining unit 30 obtains the maximum power consumptions Lmax(n) stored in the maximum individual power storage unit 34 (S131).

The timer managing unit 38 monitors whether the demand time period start time has come by comparing managed time with the demand time period start time stored by the storage unit 24 (S132: No). At the demand time period start time (S132: Yes), the timer managing unit 38 resets a demand time period timer (not illustrated) (S133).

The switch controlling unit 26 turns on the switch 5 of each demand unit 15. In this case, detecting that an inputting operation is performed normally, the electric cells 11 start to be charged (S134). The switch controlling unit 26 performs a resetting process for each demand unit 15, resulting in accumulated received power Ein_n(t)=0 (Wh) (S135).

The flow shifts to processes in FIG. 12B. The timer managing unit 38 resets a monitoring time timer (not illustrated) (S141). The timer managing unit 38 repeats a monitoring process until the monitoring time timer expires, i.e., until the monitoring time T2 elapses (S142: No). When the timer managing unit 38 determines that the monitoring time timer has expired (S142: Yes), the individual target determining unit 30 obtains the amounts of power Bn(t) remaining at time t from the demand units 15-n via the remaining power amount measurement units 12 (S143). The obtained remaining power amounts Bn(t) are expressed as ratios relative to the accumulation capacities of the electric cells 11, or as the accumulated power amounts of the electric cells 11.

The individual target determining unit 30 calculates an individual target value xn(t) for each demand unit 15 in accordance with formula 4 (S144). The switch controlling unit 26 obtains the received power Pin_n(t) (Wh) of each demand unit 15 from the received power measurement unit 9 (S145) and calculates accumulated received power Ein_n(t)=Ein_n(t)+Pin_n(t)×T2 for the demand unit 15-n (S146).

The flow shifts to processes in FIG. 12C. The switch controlling unit 26 sets k=1 (S151). The switch controlling unit 26 determines whether Ein_k(t)≧xk(t) is satisfied (S152). When Ein_k(t)<xk(t) (S152: No), the switch controlling unit 26 shifts the flow to S154. When Ein_k(t)≧xk(t) (S152: Yes), the switch controlling unit 26 turns off the switch 5 of the demand unit 15-k (power reception switch k) (S153). Detecting the disconnection of a commercial power supply caused by the inactivation of the switch 5, the power storage device 7 discharges power from the electric cell 11.

The switch controlling unit 26 sets k=k+1 (S154) and determines whether k>N is satisfied (S155). When k≦N (S155: No), the switch controlling unit 26 returns the flow to S152. When k>N (S155: Yes), the timer managing unit 38 determines whether the demand time period timer has expired (S156). When it is determined that the demand time period timer has not expired (S156: No), the flow returns to S141 in FIG. 12B; when it is determined that the demand time period timer has expired (S156: Yes), the flow returns to S133 in FIG. 12A.

As described above, the power centralized control system 1 in accordance with the second embodiment achieves operation/working effects similar to those achieved by the power centralized control systems 1 in the first embodiment and the variation thereof, and, in addition, the power consumptions of the varying loads 13 are considered in the second embodiment, thereby enabling more efficient leveling control.

### Third Embodiment

The following will describe a power centralized control system 1 in accordance with a third embodiment. Descriptions are not given herein of configurations and operations in the power centralized control system 1 in accordance with the third embodiment that are similar to those in the power centralized control systems 1 in accordance with the first embodiment and the variation thereof, or those in the power centralized control system 1 in accordance with the second embodiment. The configuration of the power centralized control system 1 in accordance with the third embodiment is similar to that of the power centralized control system 1 in accordance with the first embodiment.

In the power centralized control system 1 in accordance with the third embodiment, the individual target determining unit 30 orders individual target values xn(t) in accordance with remaining power amounts Bn(t), the maximum power consumptions Lmax(n) of the varying loads 13, or both the remaining power amounts Bn(t) and the maximum power consumptions. That is, the individual target values xn(t) are ranked in accordance with any of the following.

1) Ascending order of 1/Bn(t) (Bn(t) is in a ratio to accumulation capacity)
2) Ascending order of 1/Bn(t) (Bn(t) is accumulated power amount (Wh))
3) Ascending order of values obtained from the following formula, formula 5 (Bn(t) is in a ratio to accumulation capacity or accumulated power amount (Wh))

$$\frac{\frac{L max ( n )}{Bn ( t )}}{{\sum }_{k = 1}^{N} \frac{L max ( k )}{Bk ( t )}} \qquad ( Formula 5 )$$

According to such an order, the individual target determining unit 30 determines individual target values xn (t) such that the difference between the individual target values xn(t) of every pair of adjacent demand units 15 arranged in that order becomes equal. Formula 6 indicates a condition in which the difference between the individual target values xn(t) of every pair of adjacent demand units 15 becomes equal. FIG. 7 indicates a condition in which the overall target value x is allocated among the demand units 15.

xn(t)=x×(1+K(n,t)×β) (Formula 6)

$${\sum }_{k = 1}^{N} x ( k ) ( t ) = x \qquad ( Formula 7 )$$

Formulas 6 and 7 lead to formula 8.

$$xn ( t ) = x \times \{ 1 - K ( n , t ) \frac{2 ( N - 1 )}{N ( N + 1 )} \} \qquad ( Formula 8 )$$

In formula 8, n indicates a variable corresponding to each demand unit 15; N, the total number of demand units 15; x, the overall target value; xn(t), the individual target value of each demand unit 15 determined at time t; Bn(t), the remaining power amount of the electric cell 11 of each demand unit 15 for time t. In this case, the remaining power amount may be expressed as a percentage based on the accumulated power amount achieved when the electric cell 11 is fully charged i.e., a percentage based on an accumulation capacity, or may be a value converted into an accumulated power amount (Wh). Lmax (n) indicates the maximum power consumed by each varying load 13; K(n, t), a positive integer indicating the rank of a demand unit 15 for time t; β, a coefficient for normalization. The amounts of power remaining in the power storage devices 7 of the demand units 15 may be continuously collected, or the amounts for each monitoring time T2 may be periodically collected, and individual target values xn(t) are sequentially determined in accordance with formula 8.

The operation of the leveling control in the power centralized control system 1 in accordance with the third embodiment may be performed by determining an individual target value xn(t) using formula 8 instead of performing the process of S144 in the flowchart of FIG. 12B, i.e., a process intended for the leveling control in accordance with the second embodiment.

As described above, in the power centralized control system 1 in accordance with the third embodiment, determining the rank of an individual target value xn(t) using “1)” or “2)” according to a remaining power amount Bn(t) enables the achieving of operation/working effects similar to those achieved in the first embodiment and the variation thereof. In addition, determining the rank of an individual target value xn(t) according to a maximum power consumption Lmax (n) enables the achieving of operation/working effects similar to those achieved by the power centralized control system 1 in the second embodiment.

### Fourth Embodiment

The following will describe a power centralized control system 1 in accordance with a fourth embodiment. Descriptions are not given herein of configurations and operations in the power centralized control system 1 in accordance with the fourth embodiment that are similar to those in the power centralized control systems 1 in accordance with the first embodiment and the variation thereof or those in the power centralized control system 1 in accordance with the second or third embodiment. The configuration of the power centralized control system 1 in accordance with the fourth embodiment is similar to that of the power centralized control system 1 in accordance with the first embodiment.

As described above, in the power centralized control system 1, an individual target value xn(t) changes in accordance with a remaining power amount. However, regardless of how low an individual target value xn(t) is at a certain point in time, the accumulated received power Ein_n(t) that corresponds to the power consumed during the period from the start of a demand time period to that point in time cannot be decreased, with the result that the accumulated received power Ein_n(t) may possibly become greater than the individual target value xn(t). Meanwhile, when an individual target value xn(t) increases, a accumulated received power Ein_n(t) may increase up to the increased individual target value xn(t). Thus, the total of the accumulated received powers Ein_n(t) may exceed the overall target value x, which is the sum of the individual target values xn(t) of the demand units 15.

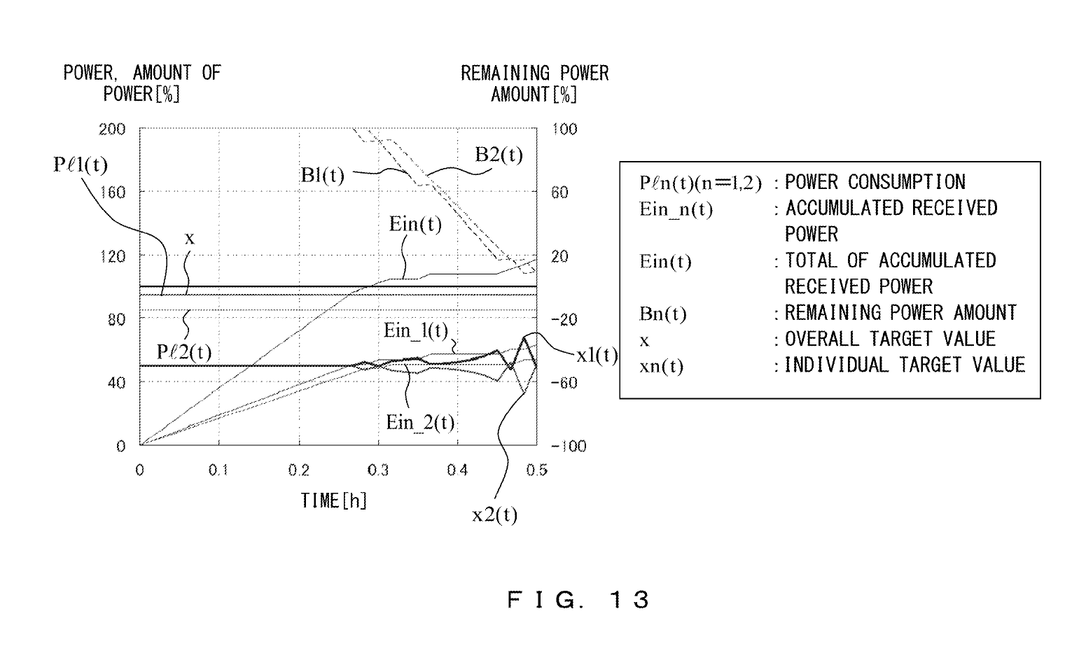

FIG. 13 illustrates a situation in which the total of accumulated received powers Ein exceeds an overall target value x. In FIG. 13, the vertical axis indicates a percentage based on the maximum power consumption Lmax (n) of each varying load 13 or based on the total of the maximum power consumptions Lmax (n) of all of the varying loads 13, or a percentage based on the amount of the maximum power consumption Lmax (n). The vertical axis also indicates a percentage based on the accumulation capacity of each demand unit 15 or based on the total of the accumulation capacities of all of the demand units 15. The horizontal axis indicates time. FIG. 13 depicts temporal changes in the received power Pin_n(t), the accumulated received powers Ein_n(t), and the remaining power amounts Bn(t) obtained in the case of performing leveling control comprehensively for the power centralized control system 1. Note that n=1, 2.

As depicted in FIG. 13, power consumptions Pl(1) and Pl(2) of the demand units 15-1 and 15-2 indicate substantially fixed values, and accumulated received powers Ein_{—}1(t) and Ein_{—}2(t) each increase to a value close to an individual target value xn(t) at around time point 0.3. When the accumulated received power amounts Ein_{—}1(t) and Ein_{—}2(t) respectively exceed individual target values x1(t) and x2(t), remaining power amounts B1(t) and B2(t) each decrease by a different amount. Then, one of the individual target values xn(t) increases, and the other decreases. As for a demand unit 15 whose individual target value xn(t) has increased, as long as that value is not exceeded, Ein_n(t) increases. As for a demand unit 15 whose individual target value xn(t) has decreased, the switch 5 is turned off and the received power thus becomes 0, but the accumulated received power Ein_n(t) simply maintains the value before the change in the individual target value xn(t), and is thus higher than the individual target value xn(t) at that moment. Accordingly, the accumulated received power Ein, i.e., the sum of the accumulated received powers Ein_{—}1(t) and Ein_{—}2(t), exceeds the overall target value x, i.e., the sum of the individual target values x1(t) and x2(t), and such an operation is indicated after time point 0.3.

As described above, in the power centralized control system 1 in accordance with the embodiment, when the total of the accumulated received powers Ein_n(t) becomes the overall target value x or greater, from among various controlling processes on the demand units 15, a process is preferentially performed of turning off the switch 5 of every demand unit 15.

The following will describe operations of the power centralized control system 1 in accordance with a fourth embodiment with reference to FIGS. 18-20. FIGS. 18-20 are flowcharts illustrating operations of the power centralized control system 1 in accordance with the fourth embodiment.

As illustrated in FIG. 14A, the leveling controlling unit 20 sets initial parameters for power leveling control in advance. That is, the timer managing unit 38 sets and stores a demand time period T1(h), a monitoring time T2(h), and a demand time period start time in the storage unit 24. The target determining unit 22 sets an overall target value x (Wh) obtained from the overall target storage unit 32. The number managing unit 36 sets a number N that corresponds to the total number of the demand units 15. In addition, the individual target determining unit 30 obtains the maximum power consumptions Lmax(n) stored in the maximum individual power storage unit 34 (S201).

The timer managing unit 38 monitors whether the demand time period start time has come by comparing managed time with the demand time period start time stored by the storage unit 24 (S202: No). At the demand time period start time (S202: Yes), the timer managing unit 38 resets a demand time period timer (not illustrated) (S203).

The switch controlling unit 26 turns on the switch 5 of each demand unit 15. In this case, detecting that an inputting operation is being performed normally, the electric cells 11 start to be charged (S204). The switch controlling unit 26 performs a resetting process for each demand unit 15, resulting in accumulated received power Ein_n(t)=0 (Wh) (S205). The switch controlling unit 26 also resets the total accumulated received power of the demand units 15, i.e., the sum of the accumulated received powers Ein_n(t) of the demand units 15, resulting in accumulated received power Ein=0 (Wh) (S206).

The flow shifts to processes in FIG. 14B. The timer managing unit 38 resets a monitoring time timer (not illustrated) (S211). The timer managing unit 38 repeats a monitoring process until the monitoring time timer expires, i.e., until the monitoring time T2 elapses (S212: No). When the timer managing unit 38 determines that the monitoring time timer has elapsed (S212: Yes), the individual target determining unit 30 obtains the amounts of power Bn(t) remaining at time t from the demand units 15-n via the remaining power amount measurement units 12 (S213). The obtained remaining power amounts Bn(t) are expressed as ratios relative to the accumulation capacities of the electric cells 11, or as the accumulated power amounts of the electric cells 11.

The individual target determining unit 30 calculates an individual target value xn(t) for each demand unit 15 in accordance with formula 4 (S214). The switch controlling unit 26 obtains the received power Pin_n(t) (Wh) of each demand unit 15 via the received power measurement unit 9 (S215) and calculates accumulated received power Ein_n(t)=Ein_n(t)+Pin_n(t)×T2 for the demand unit 15-n (S216).

The switch controlling unit 26 further calculates the overall accumulated received power Ein in accordance with the following formula, formula 9 (S217).

$$Ein ( t ) = {\sum }_{k = 1}^{N} Ein\_k ( t ) \qquad ( Formula 9 )$$

The flow shifts to processes in FIG. 14C. The switch controlling unit 26 determines whether Ein≧x is satisfied (S221). When Ein(t)≧x (S221: Yes), the switch controlling unit 26 turns off the switch 5 of every demand unit 15 (S222) and shifts the flow to S228.

When Ein(t)<x (S221: No), the switch controlling unit 26 sets k=1 (S223). The switch controlling unit 26 determines whether Ein_k(t)≧xk(t) (S224); when Ein_k(t)<xk(t) (S224: No), the switch controlling unit 26 shifts the flow to S226. When Ein_k(t)≧xk(t) (S224: Yes), the switch controlling unit 26 turns off the switch 5 of the demand unit 15-k (power reception switch k) (S225). Detecting the disconnection of a commercial power supply caused by the inactivation of the switch 5, the power storage device 7 discharges power from the electric cell 11.

The switch controlling unit 26 sets k=k+1 (S154) and determines whether k>N is satisfied (S227). When k≦N (S227: No), the switch controlling unit 26 returns the flow to S224. When k>N (S227: Yes), the timer managing unit 38 determines whether the demand time period timer has expired (S228). When it is determined that the demand time period timer has not expired (S228: No), the flow returns to S211 in FIG. 14B; when it is determined that the demand time period timer has expired (S228: Yes), the flow returns to S203 in FIG. 14A.

As described above, the power centralized control system 1 in accordance with the fourth embodiment achieves operation/working effects similar to those achieved by the power centralized control system 1 in accordance with the second embodiment, and, in addition, in the fourth embodiment, it is taken into consideration whether a accumulated received power Ein exceeds the overall target value x, so that the accumulated received power Ein can be prevented from needlessly increasing, thereby enabling more efficient leveling control.

The power leveling control methods, the power leveling control devices, and the programs in accordance with the aforementioned aspects enable safe and efficient power leveling control.

The power centralized control systems 1 in accordance with the first to fourth embodiments and the variation of the first embodiment are examples of the system of the invention. The switch controlling unit 26 is an example of the controlling unit. The individual target determining unit 30 is an example of the overall target value obtaining unit and is also an example of the individual target determining unit.

The invention is not limited to the aforementioned embodiments, and various configurations or embodiments may be used without departing from the gist of the invention. As an example, the method for determining an individual target value xn(t) in the fourth embodiment was described in view of the method for determining an individual target value xn(t) in the second embodiment, but the method is not limited to this. Any of the methods for determining an individual target value xn(t) in accordance with the first embodiment, the variation thereof, and the third embodiment may be combined with the determination of whether the sum of accumulated received powers Ein exceeds an overall target value x in the fourth embodiment.

The individual target value xn(t) of one demand unit 15 may be determined by setting a target value that is lower than the individual target value xn(t) of another demand unit 15 having a electric cell 11 whose remaining power amount Bn(t) is smaller than the remaining power amount Bn(t) of the one demand unit 15. In this case, the overall target value x is divided into the individual target values xn(t) of the demand units 15. Thus, the individual target value xn(t) of one demand unit 15 may also be determined by setting a target value that is higher than the individual target value xn(t) of another demand unit 15 having a electric cell 11 whose remaining power amount Bn(t) is larger than the remaining power amount Bn(t) of the one demand unit 15.

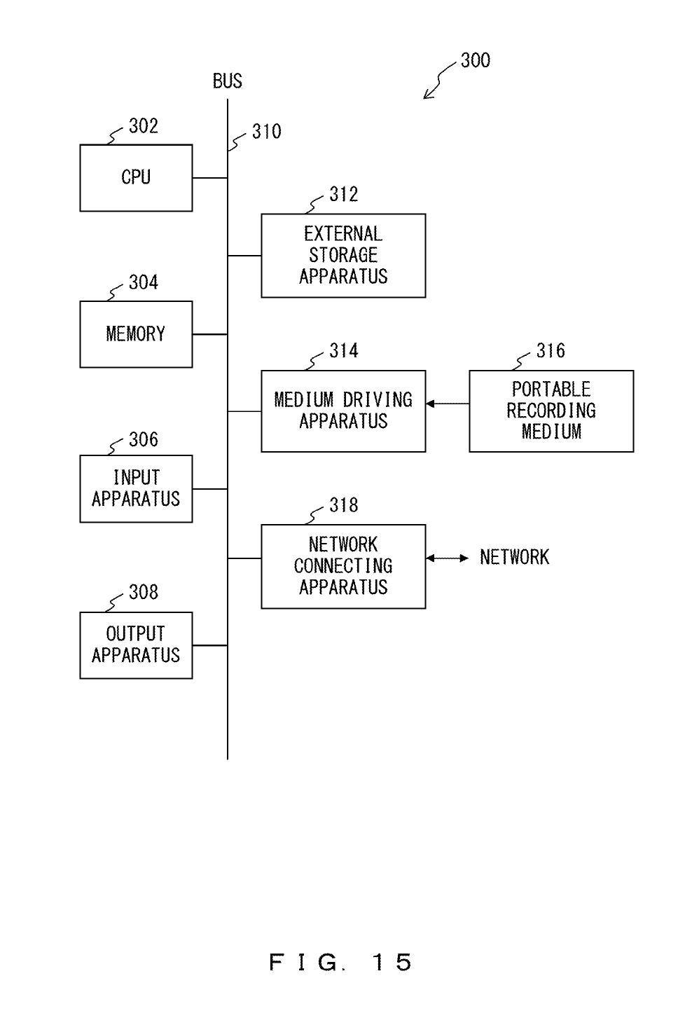

The following will describe an exemplary computer to perform the operations of the power leveling control methods in accordance with the first to fourth embodiments and the variation of the first embodiment. FIG. 15 is a block diagram illustrating an exemplary hardware configuration of a standard computer. As depicted in FIG. 15, a computer 300 includes a Central Processing Unit (CPU) 302, a memory 304, an input apparatus 306, an output apparatus 308, an external storage apparatus 312, a medium driving apparatus 314, and a network connecting apparatus, all of which are connected by a bus 310.

The CPU 302 is an processor that controls the operations of the entirety of the computer 300. The memory 304 is a storage unit in which a program for controlling operations of the computer 300 is stored in advance or which is used as a working area if necessary for execution of the program. The memory 304 is, for example, a RAM or a Read Only Memory (ROM). When the user of the computer operates the input apparatus 306, the input apparatus 306 obtains and transmits various pieces of input information associated with the operation to the CPU 302. The input apparatus 306 is, for example, a keyboard apparatus or a mouse apparatus. The output apparatus 308 outputs a result of processing by the computer 300. The output apparatus 308 includes, for example, a display apparatus. The display apparatus displays, for example, text or images in accordance with display data sent from the CPU 302.

The external storage apparatus 312, which is, for example, a hard disk, stores obtained data and various control programs executed by the CPU 302. The medium driving apparatus 314 is an apparatus to write data to and read data from a portable recording medium 316. The CPU 302 may perform various controlling processes by reading and executing a predetermined control program recorded in the portable recording medium 316 using the recording medium driving apparatus 314. The portable recording medium 316 is, for example, a Compact Disc (CD)-ROM, Digital Versatile Disc (DVD), or a Universal Serial Bus (USB) memory. The network connecting apparatus 318 is an interface apparatus that manages exchange of various pieces of data with an external element performed through a wired or wireless communication. The bus 310 is a communication path which connects, for example, the aforementioned apparatuses to each other and through which data is exchanged.

A program for causing a computer to perform the power leveling control methods in accordance with the first to fourth embodiments and the variation of the first embodiment is stored in, for example, the external storage apparatus 312. The CPU 302 reads the program from the external storage apparatus 312 and causes the computer 300 to perform the operations of power leveling control. In this case, a control program for causing the CPU 302 to perform the operations of power leveling control is created and stored in the external storage apparatus 312 in advance. A predetermined instruction is given to the CPU 302 using the input apparatus 306 so as to read the control program from the external storage apparatus 312 for execution. That program may be stored in the portable recording medium 316.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power leveling control method that performs leveling power supplied from a power supply to a plurality of demand units in a system that includes the power supply connected to the plurality of demand units provided with a power storage device and a load, the power leveling control method comprising:
obtaining, by a processor, an overall target value for a total of the power supplied to the plurality of demand units;
obtaining, by the processor, a remaining power amount of the power storage device of each of the demand units for each monitoring time;
setting, by the processor, an individual target value of one demand unit to a value that is lower than an individual target value of another demand unit, in allocating the individual target value for power supplied to each of the demand units in accordance with the overall target value, when a remaining power amount of the another demand unit is smaller than a remaining power amount of the one demand unit; and
controlling, by the processor, the power supplied from the power storage device to the loads or the power supplied from the power supply to the power storage device according to the individual target values.

2. The power leveling control method according to claim 1, wherein
the individual target values are determined according to a reciprocal ratio between the remaining power amounts of the demand units.

3. The power leveling control method according to claim 2, wherein
the individual target values are further determined according to a ratio between maximum power consumptions of the demand units.

4. The power leveling control method according to claim 1, further comprising:
measuring amounts of power received by the demand units or amounts of power supplied per unit time; and
controlling a sum of the measured amounts of power or a sum of the measured amounts of power supplied per unit time according to the overall target value when the sum of the measured amounts of power received by the demand units or the sum of the measured amounts of power supplied per unit time is equal to or greater than the overall target value.

5. A power leveling control device that performs leveling power supplied from a power supply to a plurality of demand units in a system that includes the power supply connected to the plurality of demand units provided with a power storage device and a load, the power leveling control device comprising
a processor configured to obtain an overall target value for a total of the power supplied to the plurality of demand units, to obtain a remaining power amount of the power storage device of each of the demand units for each monitoring time, to set an individual target value of one demand unit to a value that is lower than an individual target value of another demand unit, in allocating the individual target value for power supplied to each of the demand units in accordance with the overall target value, when a remaining power amount of the another demand unit is smaller than a remaining power amount of the one demand unit, and to control the power supplied from the power storage device to the loads or the power supplied from the power supply to the power storage device according to the individual target values.

6. The power leveling control device according to claim 5, wherein
the individual target values are determined according to a reciprocal ratio between the remaining power amounts of the demand units.

7. The power leveling control device according to claim 6, wherein
the individual target values are further determined according to a ratio between maximum power consumptions of the demand units.

8. The power leveling control device according to claim 5, wherein
the processor further
measures amounts of power received by the demand units or amounts of power supplied per unit time; and
controls a sum of the measured amounts of power or a sum of the measured amounts of power supplied per unit time according to the overall target value when the sum of the measured amounts of power received by the demand units or the sum of the measured amounts of power supplied per unit time is equal to or greater than the overall target value.

9. A computer-readable recording medium having stored therein a program for causing a computer to execute a process for leveling power supplied from a power supply to a plurality of demand units, in a system that includes the power supply connected to the plurality of demand units provided with a power storage device and a load, the process comprising:
obtaining an overall target value for a total of the power supplied to the plurality of demand units;
obtaining a remaining power amount of the power storage device of each of the demand units for each monitoring time;
setting an individual target value of one demand unit to a value that is lower than an individual target value of another demand unit in allocating an individual target value for power supplied to each of the demand units in accordance with the overall target value, when a remaining power amount of the another demand unit is smaller than a remaining power amount of the one demand unit; and
controlling the power supplied from the power storage device to the loads or the power supplied from the power supply to the power storage device according to the individual target values.

10. The computer-readable recording medium according to claim 9, wherein
the individual target values are determined according to a reciprocal ratio between the remaining power amounts of the demand units.

11. The computer-readable recording medium according to claim 10, wherein
the individual target values are further determined according to a ratio between maximum power consumptions of the demand units.

12. The computer-readable recording medium according to claim 9, wherein
the process further comprising:
measuring amounts of power received by the demand units or amounts of power supplied per unit time; and
controlling a sum of the measured amounts of power or a sum of the measured amounts of power supplied per unit time according to the overall target value when the sum of the measured amounts of power received by the demand units or the sum of the measured amounts of power supplied per unit time is equal to or greater than the overall target value.
